(19) United States
(12) Patent Application Publication
(10) Pub. No.: US 2025/0296801 A1
(43) Pub. Date: Sep. 25, 2025

(54) MEDIUM PROCESSING APPARATUS AND IMAGE FORMING SYSTEM

(71) Applicants: Kensuke FUKUCHI, Kanagawa (JP); Kei SASAKI, Kanagawa (JP); Kazuki SETO, Kanagawa (JP); Shohei SAITO, Kanagawa (JP); Keisuke SUGIYAMA, Kanagawa (JP)

(72) Inventors: Kensuke FUKUCHI, Kanagawa (JP); Kei SASAKI, Kanagawa (JP); Kazuki SETO, Kanagawa (JP); Shohei SAITO, Kanagawa (JP); Keisuke SUGIYAMA, Kanagawa (JP)

(73) Assignee: Ricoh Company, Ltd., Tokyo (JP)

(21) Appl. No.: 19/079,041

(22) Filed: Mar. 13, 2025

(30) Foreign Application Priority Data
Mar. 21, 2024 (JP) 2024-045516

(51) Int. Cl. B65H 37/04; B41J 3/44; B65H 43/00; G03G 15/00

(52) U.S. Cl. CPC B65H 37/04; B65H 43/00; B41J 3/44; B65H 2301/5161; B65H 2301/5162; B65H 2513/50; B65H 2801/27; G03G 15/6544

(57) ABSTRACT

A medium processing apparatus includes a liquid applier to apply liquid to a part of a medium to perform a liquid application, a medium processing device to perform desired processing on a bundle of media including the medium subjected to the liquid application, a liquid storage to store liquid used for the liquid application by the liquid applier, a liquid detector to detect an amount of liquid in the liquid storage, and circuitry to control a supply operation of supplying the liquid to the liquid applier to set a liquid applicable state in which the liquid applier can apply the liquid to the at least one medium based on information from the liquid detector. The circuitry changes a transition time to the liquid applicable state, based on the amount of liquid in the liquid storage detected by the liquid detector.

### CROSS-REFERENCE TO RELATED APPLICATION

This patent application is based on and claims priority pursuant to 35 U.S.C. § 119 (a) to Japanese Patent Application No. 2024-045516, filed on Mar. 21, 2024, in the Japan Patent Office, the entire disclosure of which is hereby incorporated by reference herein.

### BACKGROUND

### Technical Field

The present disclosure relates to a medium processing apparatus and an image forming system.

### Related Art

Various types of medium processing apparatuses have been proposed that bind a sheet bundle of stacked sheet media. A plurality of binding processes applicable to such medium processing apparatuses have been proposed. Examples of the binding processes include a “stapling process” that causes a stapling member (binding member) to insert through a sheet bundle to bind the sheet bundle and a “crimp binding process” that deforms a part of a sheet bundle by pressure to bind the sheet bundle.

Examples of the crimp binding process include a liquid-application crimp-binding process that applies liquid to a pressing position of a sheet bundle (or each sheet forming the sheet bundle) before pressing the sheet bundle, to increase binding strength. In the present specification, the application of liquid to a medium, which is performed with the crimp binding process, is referred to as “liquid application.” In addition, executing a series of processes for performing the liquid application is referred to as “performing liquid application.”

In addition, in order to obtain an appropriate binding force in a crimp binding device that enables liquid-application crimp binding, a configuration has been proposed that changes the amount of water added (the amount of liquid in liquid application) according to the number of sheets or the type of medium to be bound.

### SUMMARY

The present disclosure described herein provides a medium processing apparatus that includes a liquid applier to apply liquid to a part of a medium to perform a liquid application, a medium processing device to perform desired processing on a bundle of media including the medium subjected to the liquid, a liquid storage to store liquid used for the liquid application by the liquid applier, a liquid detector to detect an amount of liquid in the liquid storage, and circuitry to control a supply operation of supplying the liquid to the liquid applier to set a liquid applicable state in which the liquid applier can apply the liquid to the at least one medium based on information from the liquid detector. The circuitry changes a transition time to the liquid applicable state, based on the amount of liquid in the liquid storage detected by the liquid detector.

The present disclosure described herein also provides an image forming system that includes an image forming device to form an image on media constituting a bundle of media, a liquid applier to apply liquid to a part of a medium to perform a liquid application, a medium processing device to perform desired processing on the bundle of media on which the image is formed by the image forming device, the bundle of media including the medium subjected to the liquid application, a liquid storage to store liquid used for the liquid application by the liquid applier, a liquid detector to detect an amount of liquid in the liquid storage, and circuitry configured to control a supply operation of supplying the liquid to the liquid applier to set a liquid applicable state in which the liquid applier can apply the liquid to the at least one medium based on information from the liquid detector. The circuitry changes a transition time to the liquid applicable state, based on the amount of liquid in the liquid storage detected by the liquid detector.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system;

FIG. 2 is a diagram illustrating an internal structure of a post-processing apparatus according to a first embodiment of the present disclosure.

FIG. 3 is a schematic view of an edge binder viewed from an upstream side in a conveyance direction;

FIG. 4 is a schematic view of an edge binder viewed from the side on which a liquid applier is located in a main scanning direction;

FIGS. 5A and 5B are schematic diagrams illustrating a configuration of a crimper of an edge binder;

FIG. 6 is a schematic view of a staple binder viewed from an upstream side in a conveyance direction;

FIG. 7 is a schematic view of a staple binder according to a modification, viewed from an upstream side in a conveyance direction;

FIGS. 8A and 8B are diagrams illustrating a location and configuration of a second liquid storage tank in a post-processing apparatus;

FIG. 9 is a diagram illustrating a configuration of attachment and detachment of a second liquid storage tank in a post-processing apparatus;

FIG. 10 is a block diagram illustrating a hardware configuration of the post-processing apparatus of FIG. 2 to control the post-processing apparatus;

FIG. 11 is a flowchart of a binding process performed by an edge binder;

FIGS. 12A, 12B, and 12C are diagrams illustrating positions of a liquid applier and a crimper during a binding process by an edge binder;

FIGS. 13A, 13B, 13C, and 13D are diagrams illustrating an outline of a filling supply operation which is one of liquid supply/discharge modes;

FIGS. 14A and 14B are flowcharts of a control process of a filling supply operation;

FIGS. 15A and 15B are diagrams illustrating liquid supply control according to a comparative example;

FIG. 16 is a diagram illustrating a permeation lower-limit liquid level in a first liquid storage tank according to the first embodiment;

FIGS. 17A and 17B are diagrams illustrating replenishment of liquid to the first liquid storage tank according to the first embodiment;

FIGS. 18A and 18B are diagrams illustrating replenishment of liquid to the first liquid storage tank according to the first embodiment;

FIGS. 19A, 19B, and 19C are flowcharts of a liquid supply determination process according to the first embodiment;

FIGS. 20A, 20B, and 20C are diagrams illustrating replenishment of liquid to the first liquid storage tank according to the first embodiment;

FIG. 21 is a diagram illustrating an example of display of an operation panel according to the first embodiment;

FIG. 22 is a diagram illustrating an internal configuration of a post-processing apparatus according to a second embodiment;

FIGS. 23A, 23B, and 23C are schematic views of an internal tray according to the second embodiment, viewed from a thickness direction of a sheet;

FIG. 24 is a schematic view of a crimper according to the second embodiment, viewed from an upstream side in a conveyance direction;

FIGS. 25A and 25B are schematic views of a liquid applier according to the second embodiment, viewed from a thickness direction of a sheet;

FIGS. 26A, 26B, and 26C are cross-sectional views of a liquid application unit of the liquid applier taken through XXV-XXV of FIG. 25A;

FIGS. 27A, 27B, and 27C are cross-sectional views of the liquid application unit of the liquid applier taken through XXVI-XXVI of FIG. 25A;

FIG. 28 is a block diagram illustrating a hardware configuration of control of the post-processing apparatus according to the second embodiment;

FIG. 29 is a flowchart of post-processing performed by the post-processing apparatus according to the second embodiment;

FIG. 30 is a diagram illustrating an overall configuration of an image forming system according to a modification;

FIGS. 31A and 31B are diagrams each illustrating a post-processing apparatus including a controller according to a modification; and

FIGS. 32A and 32B are diagrams each illustrating a post-processing apparatus including a controller according to a modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the accompanying drawings. Note that identical parts are given identical reference signs and redundant descriptions are summarized or omitted accordingly. In the following description, a liquid discharge head that discharge ink as an exemplary liquid is described.

A description is given below of an image forming system 1 according to an embodiment of the present disclosure, with reference to the drawings.

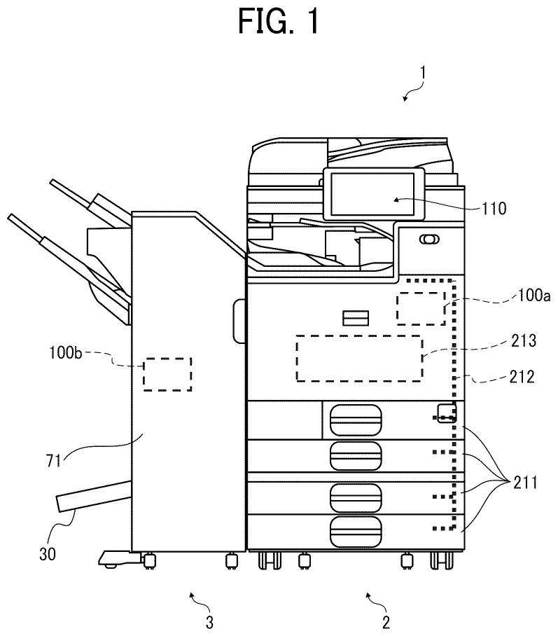

FIG. 1 is a diagram illustrating an overall configuration of the image forming system 1. The image forming system 1 has, for example, an image forming function of forming an image on a sheet P as an example of a sheet-shaped medium and a post-processing function of performing post-processing on the sheet P on which the image has been formed. As illustrated in FIG. 1, the image forming system 1 includes an image forming apparatus 2 having the image forming function and a post-processing apparatus 3 serving as a media processing apparatus having the post-processing function according to an embodiment of the present disclosure. In the image forming system 1, the image forming apparatus 2 and the post-processing apparatus 3 operate in conjunction with each other.

The present embodiment is described on the assumption that the sheet-shaped medium to be processed in the image forming system 1 is a sheet of “paper.” However, the object to be processed according to the present embodiment is not limited to a sheet of paper. For example, any type of medium may be used as long as an image can be formed on the medium according to an image forming process. Examples of the medium include any medium that can be an object of a folding process or a binding process, and the material or specification of the medium is not limited to any particular material or specification.

The image forming apparatus 2 forms an image on the sheet P and ejects the sheet P having the image to the post-processing apparatus 3. The image forming apparatus 2 includes an accommodation tray 211 that accommodates sheets P, a conveyor 212 that conveys a sheet P from the accommodation tray 211, and an image forming device 213 that forms an image on the sheet P conveyed by the conveyor 212. The image forming device 213 may be an inkjet system that forms an image using ink or an electrophotographic system that forms an image using toner. The image forming apparatus 2 also includes a controller 100a that controls various operations of the conveyor 212 and the image forming device 213. Since the image forming apparatus 2 has a typical configuration, a detailed description of the configuration is omitted.

Sheets of paper are widely known as an example of sheet-shaped media. In the following description, a sheet-shaped medium as a medium to be processed is referred to as a “sheet P.” Further, in the following description, a bundle of sheets of paper as a plurality of media is an example of a “sheet bundle Pb.”

A description is given below of the post-processing apparatus 3 according to a first embodiment.

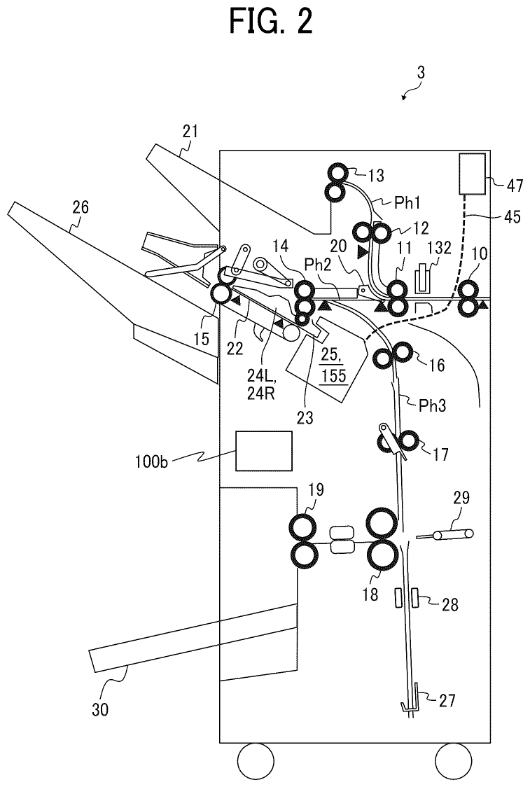

FIG. 2 is a diagram illustrating an internal structure of the post-processing apparatus 3 according to the first embodiment. The post-processing apparatus 3 has a function that performs post-processing on the sheet P on which an image has been formed by the image forming apparatus 2. An example of the post-processing according to the present embodiment is a binding process as a “crimp binding process” that binds, without staples, a plurality of sheets P on each of which an image is formed as a bundle of sheets, which may be referred to as a sheet bundle. Another example of the post-processing according to the present embodiment is a binding process as a “stapling process” that binds, with staples, a plurality of the sheets P on each of which an image is formed as a bundle of sheets P (i.e., sheet bundle). In the following description, the bundle of sheets may be referred to as a “sheet bundle Pb” as a bundle of media.

In the present embodiment, a description is typically given of liquid application in a crimp binding process. However, liquid application performed in a stapling process is similar to the liquid application in the crimp binding process. In the following description, the term “binding process” indicates both the “crimp binding process” and the “stapling process”, and is not limited to any particular binding method (whether a staple is used or pressing deformation is performed).

More specifically, the “crimp binding process” according to the present embodiment is a process called “crimp binding” to apply pressure to the binding position corresponding to a part of a sheet bundle Pb to deform (pressure-deform) the binding position and bind the sheet bundle Pb. The binding that can be executed by the post-processing apparatus 3 includes edge binding and saddle binding. The edge binding is a process to bind an end (including an edge) of the sheet bundle Pb. The saddle binding is a process to bind the center of the sheet bundle Pb.

The post-processing apparatus 3 includes conveyance roller pairs 10 to 19 (an example of conveyors), a switching member 20, and a controller 100b (an example of a control device or circuitry). The controller 100b controls the operations of, for example, the conveyance roller pairs 10 to 19 (an example of conveyors), and the switching member 20. Details of the controller 100b will be described below. The conveyance roller pairs 10 to 19 convey, inside the post-processing apparatus 3, a sheet P supplied from the image forming apparatus 2. Specifically, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3. A hole punch 132 is disposed between the conveyance roller pairs 10 and 11. The hole punch 132 performs punching on the sheet P conveyed by the conveyance roller pairs 10 and 11.

The first conveyance passage Ph1 is a passage extending to a first ejection tray 21 from a supply port through which the sheet P is supplied from the image forming apparatus 2. The second conveyance passage Ph2 is a passage branching from the first conveyance passage Ph1 between the conveyance roller pairs 11 and 14 in a conveyance direction and extending to a second ejection tray 26 via an internal tray 22. The third conveyance passage Ph3 is a passage branching from the first conveyance passage Ph1 between the conveyance roller pairs 11 and 14 in the conveyance direction and extending to an ejection tray 30.

The switching member 20, which is an example of a switcher, is disposed at a branching position of the first conveyance passage Ph1 and the second conveyance passage Ph2. The switching member 20 can be switched between a first position and a second position. The switching member 20 in the first position guides the sheet P to be ejected to the first ejection tray 21 through the first conveyance passage Ph1. The switching member 20 in the second position guides the sheet P conveyed through the first conveyance passage Ph1 to the second conveyance passage Ph2. When a trailing end of the sheet P entering the second conveyance passage Ph2 passes through the conveyance roller pair 11, the conveyance roller pair 14 is rotated in reverse to guide the sheet P to the third conveyance passage Ph3. The post-processing apparatus 3 further includes a plurality of sensors that detects the positions of the sheet P in the first conveyance passage Ph1, the second conveyance passage Ph2, and the third conveyance passage Ph3. Each of the sensors is indicated by a black triangle in FIG. 2.

The post-processing apparatus 3 includes the first ejection tray 21. The sheet P that is output through the first conveyance passage Ph1 is placed on the first ejection tray 21. Among the sheets P supplied from the image forming apparatus 2, the sheets P that are not bound are ejected to the first ejection tray 21.

The post-processing apparatus 3 further includes the internal tray 22, which is an example of a placement tray, an end fence 23, side fences 24L and 24R, an edge binder 25, which is an example of a medium processing device, a staple binder 155, and a second ejection tray 26. The internal tray 22, the end fence 23, the side fences 24L and 24R, the edge binder 25, and the staple binder 155 perform edge binding on the sheet bundle Pb including multiple sheets P conveyed from the second conveyance passage Ph2 to the internal tray 22. Among the sheets P supplied from the image forming apparatus 2, the sheet bundle Pb subjected to the edge binding is ejected to the second ejection tray 26.

The “edge binding process” here means a binding process performed by the edge binder 25 and the staple binder 155. Specifically, the “edge binding process” includes, but not limited to, a “parallel binding process” that binds the sheet bundle Pb along one side of the sheet bundle Pb parallel to the main scanning direction, an “oblique binding process” that binds a corner of the sheet bundle Pb, and a “vertical binding process” that binds the sheet bundle Pb along one side of the sheet bundle Pb parallel to the conveyance direction.

In the following description, a direction in which the sheet P is conveyed from the conveyance roller pair 15 toward the end fence 23 is defined as a “conveyance direction.” In other words, the “conveyance direction” herein corresponds to a direction in which the sheet P that has been output from the image forming apparatus 2 is moved toward the second ejection tray 26 by, for example, the conveyance roller pair 10, is changed to move toward the end fence 23 by the conveyance roller pair 15 in a direction different from the above-described direction. The direction that is orthogonal to both the conveyance direction and a thickness direction of the sheet P is defined as a “main scanning direction” or a “width direction of the sheet P.”

The sheets P that are sequentially conveyed through the second conveyance passage Ph2 are temporarily placed on the internal tray 22, which is an example of a placement tray. The end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 155 perform edge binding on the sheet bundle Pb aligned by the end fence 23 and the side fences 24L and 24R. Then, the conveyance roller pair 15 ejects the sheet bundle Pb subjected to the edge binding to the second ejection tray 26.

The post-processing apparatus 3 further includes an end fence 27, a saddle binder 28, a sheet folding blade 29, and the ejection tray 30. The end fence 27, the saddle binder 28, and the sheet folding blade 29 perform the saddle binding on the sheet bundle Pb of the sheets P that are conveyed through the third conveyance passage Ph3. Among the sheets P supplied from the image forming apparatus 2, the sheet bundle Pb subjected to the saddle binding is ejected to the ejection tray 30.

The end fence 27 aligns the positions of the sheets P that are sequentially conveyed through the third conveyance passage Ph3, in a conveyance direction in which the sheets P are conveyed. The end fence 27 can move between a binding position where the end fence 27 causes the center of the sheet bundle Pb to face the saddle binder 28 and a folding position where the end fence 27 causes the center of the sheet bundle Pb to face the sheet folding blade 29. The saddle binder 28 binds the center of the sheet bundle Pb aligned by the end fence 27 at the binding position. The sheet folding blade 29 folds, in half, the sheet bundle Pb placed on the end fence 27 at the folding position and causes the conveyance roller pair 18 to nip the sheet bundle Pb. The conveyance roller pairs 18 and 19 eject the sheet bundle Pb subjected to the saddle binding to the ejection tray 30.

In addition, the post-processing apparatus 3 includes a liquid application member 501 (a part of the liquid applier), a liquid supply member 50 (a part of the liquid applier), and a first liquid storage tank 44 (a first liquid storage) in the edge binder 25. The first liquid storage tank 44 and the liquid supply member 50 are omitted in FIG. 2. The post-processing apparatus 3 includes a liquid supply passage 45 (a part of the liquid supplier), a liquid supply pump 46 (a part of the liquid supplier), a second liquid storage tank 47 (a part of the second liquid storage unit), and a second-liquid-storage-tank fixer 61 (a part of the second liquid storage unit) as a configuration for replenishing the first liquid storage tank 44 with the liquid. The liquid that is stored in the second liquid storage tank 47 is supplied to the first liquid storage tank 44 via the second-liquid-storage-tank fixer 61, the liquid supply pump 46, and the liquid supply passage 45.

A description is given below of the edge binder 25.

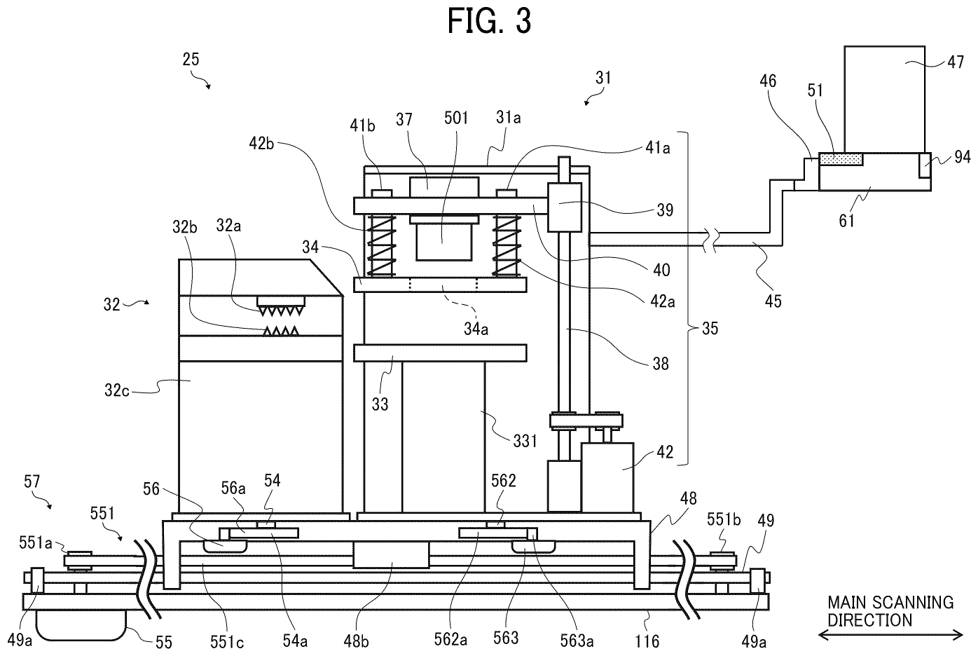

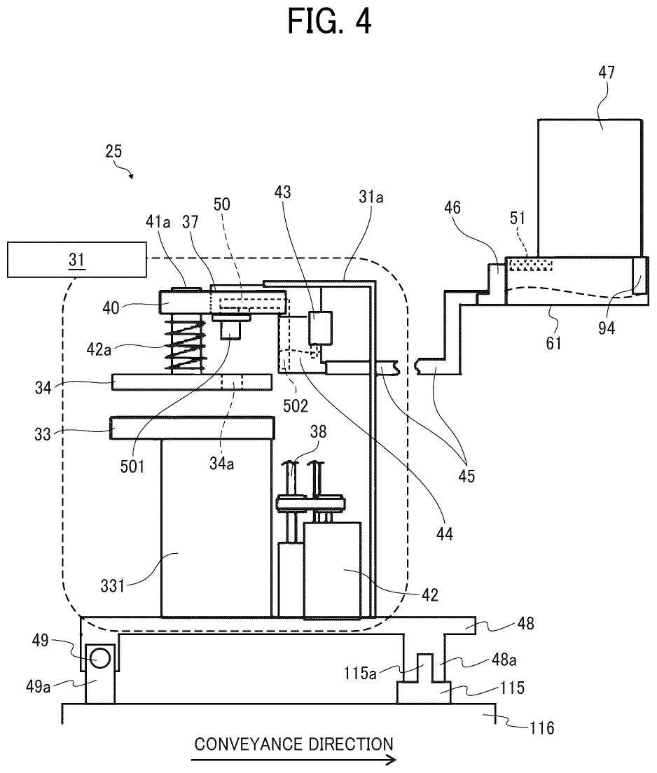

FIG. 3 is a schematic diagram illustrating the edge binder 25 of FIG. 2 that performs liquid application and crimp binding, as viewed from an upstream side thereof in the conveyance direction. FIG. 4 is a schematic diagram of the edge binder 25 viewed from the side on which a liquid applier 31 is disposed in the main scanning direction. As illustrated in FIG. 3, the edge binder 25 includes the liquid applier 31 that applies liquid to the sheet P or the sheet bundle Pb, and a crimper 32 that is an example of a post-processing device and performs crimp binding on the sheet bundle Pb. The liquid applier 31 and the crimper 32 are disposed downstream from the internal tray 22 in the conveyance direction and adjacent to each other in the main scanning direction.

As illustrated in FIG. 4, the liquid applier 31 applies the liquid stored in the first liquid storage tank 44 to the sheet P or the sheet bundle Pb placed on the internal tray 22. The application of the liquid to the sheet P or the sheet bundle Pb by the liquid applier 31 and the operation of the liquid applier 31 in applying the liquid are referred to as “liquid application” below. The liquid applying operation of the liquid applier 31 involving control processing is referred to as a “liquid application process.”

More specifically, the liquid that is stored in the first liquid storage tank 44 as liquid for the “liquid application” includes, as a main component, the liquid state of a compound of hydrogen and oxygen compound represented by the chemical formula H₂O. The temperature condition is not limited, and the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid that is stored in the first liquid storage tank 44 may include an additive in addition to the main component. The liquid that is stored in the first liquid storage tank 44 may include residual chlorine used as tap water. Preferably, for example, the liquid that is stored in the first liquid storage tank 44 may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, in comparison with a liquid of which the main component is not water (liquid).

A description is given of a configuration of the liquid applier 31.

As illustrated in FIGS. 3 and 4, the liquid applier 31 is movable in the main scanning direction together with the crimper 32 by a driving force transmitted from an edge-binder movement motor 55. The liquid applier 31 includes a lower pressure plate 33, which is an example of a receptacle for the sheet P or the sheet bundle Pb, an upper pressure plate 34, and a liquid-applier movement assembly 35. The components of the liquid applier 31 (the lower pressure plate 33, the upper pressure plate 34, the liquid-applier movement assembly 35, and a liquid-application-unit movement motor 42) are held by a liquid application frame 31a and a base 48.

A liquid applier shaft 562 including a drive transmission gear 562a is fixed to a bottom face of the liquid application frame 31a that holds the components of the liquid applier 31. The liquid applier shaft 562 and the drive transmission gear 562a are held by the base 48 on which the liquid application frame 31a is disposed, so as to be rotatable in the forward and reverse directions. The drive transmission gear 562a meshes with an output gear 563a of a liquid-applier pivot motor 563. The liquid applier 31 can be rotated in the forward and reverse directions about the liquid applier shaft 562 on the base 48 by a driving force transmitted from the liquid-applier pivot motor 563 to the liquid applier shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is disposed on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22.

In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction.” Further, the upper pressure plate 34 is provided with a through hole 34a passing through the upper pressure plate 34 in the thickness direction at a position opposite to the liquid application member 501 held via a holder 37 attached to the base plate 40. The liquid application member 501 is one end portion of a liquid supply member 50 (liquid absorber) described below and corresponds to a tip portion of the liquid supply member 50.

The liquid-applier movement assembly 35 moves the upper pressure plate 34, the base plate 40, the holder 37, the liquid application member 501, the liquid supply member 50, and the first liquid storage tank 44 in the thickness direction of the sheet P or the sheet bundle Pb. The liquid-applier movement assembly 35 according to the present embodiment moves the upper pressure plate 34, the base plate 40, the holder 37, the liquid application member 501, the liquid supply member 50, and the first liquid storage tank 44 in conjunction with each other with a single liquid-application-unit movement motor 42. The liquid-applier movement assembly 35 includes, for example, the liquid-application-unit movement motor 42, a trapezoidal screw 38, a nut 39, the base plate 40, columns 41a and 41b, and coil springs 42a and 42b.

The liquid-application-unit movement motor 42 generates a driving force to move the upper pressure plate 34, the base plate 40, the holder 37, the liquid application member 501, the liquid supply member 50, and the first liquid storage tank 44. The trapezoidal screw 38 extends in the thickness direction of the sheet P or the sheet bundle Pb and is provided with the liquid application frame 31a such that the trapezoidal screw 38 is rotatable in the forward and reverse directions. The trapezoidal screw 38 is coupled to an output shaft of the liquid-application-unit movement motor 42 via, for example, a pulley and a belt. The nut 39 is screwed to the trapezoidal screw 38. The trapezoidal screw 38 is rotated in the forward and reverse directions by the driving force transmitted from the liquid-application-unit movement motor 42. The rotation of the trapezoidal screw 38 causes the nut 39 to reciprocate on the trapezoidal screw 38.

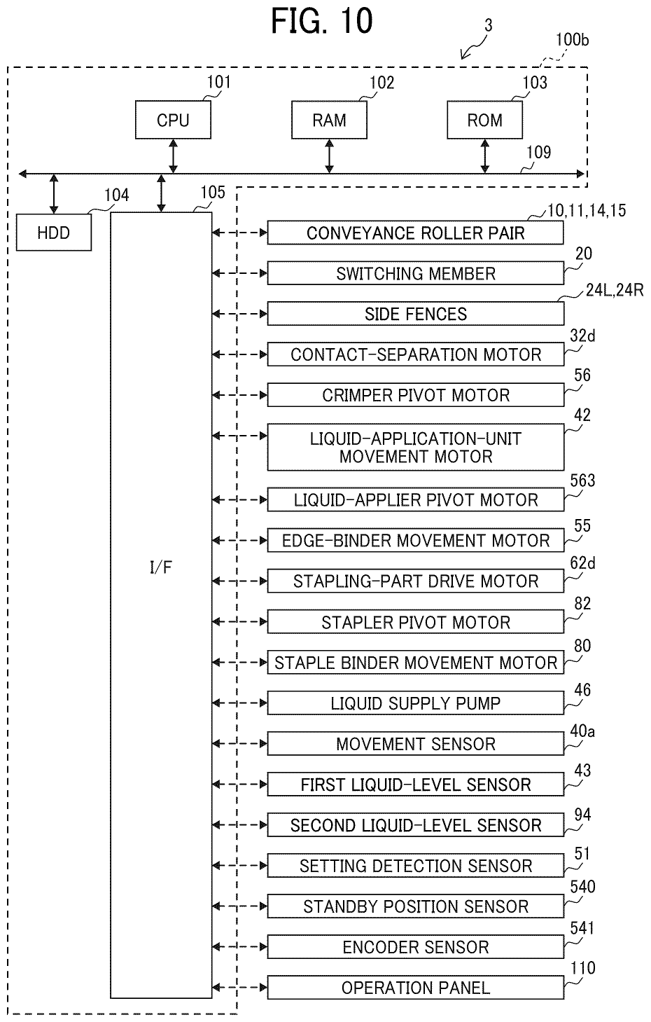

The base plate 40 is positioned apart from the upper pressure plate 34. The base plate 40 holds the liquid application member 501 with the tip portion of the liquid application member 501 protruding from the base plate 40 toward the upper pressure plate 34. The base plate 40 is coupled to the trapezoidal screw 38 via the nut 39 such that base plate 40 can reciprocate along the trapezoidal screw 38 as the trapezoidal screw 38 rotates in the forward and reverse directions. The position of the base plate 40 in the thickness direction of the sheet P or the sheet bundle Pb is detected by a movement sensor 40a (see FIG. 10).

The columns 41a and 41b project from the base plate 40 toward the upper pressure plate 34 around the tip portion of the liquid application member 501. The columns 41a and 41b can relatively move with respect to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40.

The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid applier 31 performs liquid application on the sheet P or the sheet bundle Pb placed on the internal tray 22. Specifically, the liquid applier 31 brings the liquid application member 501 into contact with the sheet P or the sheet bundle Pb to perform liquid application on at least one sheet P of the sheet bundle Pb. The liquid may be applied to each of the sheets P included in the sheet bundle Pb.

The liquid applier 31 includes a first liquid-level sensor 43 (an example of a first liquid detector), the first liquid storage tank 44, the liquid application member 501, the liquid supply member 50, and the holder 37. The first liquid storage tank 44 stores the liquid to be applied to the sheet P or the sheet bundle Pb. The amount of liquid that is stored in the first liquid storage tank 44 is detected by the first liquid-level sensor 43. The first liquid storage tank 44 is coupled to the base plate 40 via the holder 37.

The liquid application member 501 applies the liquid stored in the first liquid storage tank 44 to the sheet P or the sheet bundle Pb. The liquid application member 501, the liquid supply member 50 (an example of a liquid absorber) disposed in close contact with the liquid application member 501, and the first liquid storage tank 44 are held by the holder 37. The holder 37 is held by the base plate 40. The liquid supply member 50 has a first end in close contact with the liquid application member 501 and a second end immersed in the liquid stored in the first liquid storage tank 44. In other words, the second end of the liquid supply member 50 corresponds to a liquid immersion portion 502 that absorbs and draws up the liquid and supplies the liquid to the liquid application member 501. The liquid application member 501 and the liquid supply member 50 are made of a material (e.g., sponge or fiber) having a high liquid absorption rate, such as an elastic resin formed of open cells. However, at least one of the liquid application member 501 or the liquid supply member 50 is not limited to a particular type as long as the at least one of the liquid application member 501 or the liquid supply member 50 is made of a material having properties of absorbing and holding the liquid and has a property of being crushable in accordance with a pressing force applied when the at least one of the liquid application member 501 or the liquid supply member 50 is in contact with the sheet P. In other words, at least one of the liquid application member 501 and the liquid supply member 50 may be made of any material as long as the material can absorb or draw up liquid by capillary action.

Accordingly, when the other end portion (the liquid immersion portion 502) of the liquid supply member 50 is immersed in the liquid stored in the first liquid storage tank 44, the liquid supply member 50 sucks up the liquid by capillary action. In other words, the liquid stored in the first liquid storage tank 44 is sucked up from a liquid immersion portion 502 of the liquid supply member 50, and the sucked liquid is supplied to the liquid application member 501 that is coupled to the tip portion via the liquid supply member 50. Then, the liquid stored in the first liquid storage tank 44 is drawn up to the liquid application member 501 in close contact with one end portion of the liquid supply member 50, and thus the liquid level (stored liquid amount) of the liquid stored in the first liquid storage tank 44 detected by the first liquid-level sensor 43 is lowered. As a result, the liquid is supplied from the second liquid storage tank 47 to the first liquid storage tank 44 by the liquid supply pump 46.

Although the case where the liquid supply member 50 and the liquid application member 501 are separate bodies has been described above, the liquid supply member 50 and the liquid application member 501 may be integrally formed of a material having the same properties (for example, a material having a high liquid absorption rate). In other words, the liquid application member 501 may be part of the liquid supply member 50. In such a case, liquid can be supplied from the liquid supply member 50 to the liquid application member 501 more smoothly by the capillary action and a reduction in cost can be achieved.

At this time, the liquid application member 501 draws up the liquid stored in the first liquid storage tank 44. By so doing, the amount of liquid (liquid level) in the first liquid storage tank 44 temporarily decreases to the level below the reference liquid level described below. In response to this decrease of liquid in the first liquid storage tank 44, a series of liquid supply operations for feeding liquid from the second liquid storage tank 47 to the first liquid storage tank 44 is performed. This series of liquid supply operations is mainly performed at the time of activation of the post-processing apparatus 3 or at the time of start of execution of the binding processing involving liquid application in the post-processing apparatus 3, and corresponds to the liquid supply operations for bringing the liquid application using the liquid application member 501 to be executable. In the following description, the liquid supply operation is referred to as a “filling supply operation.” Details of the filling supply operation will be described later.

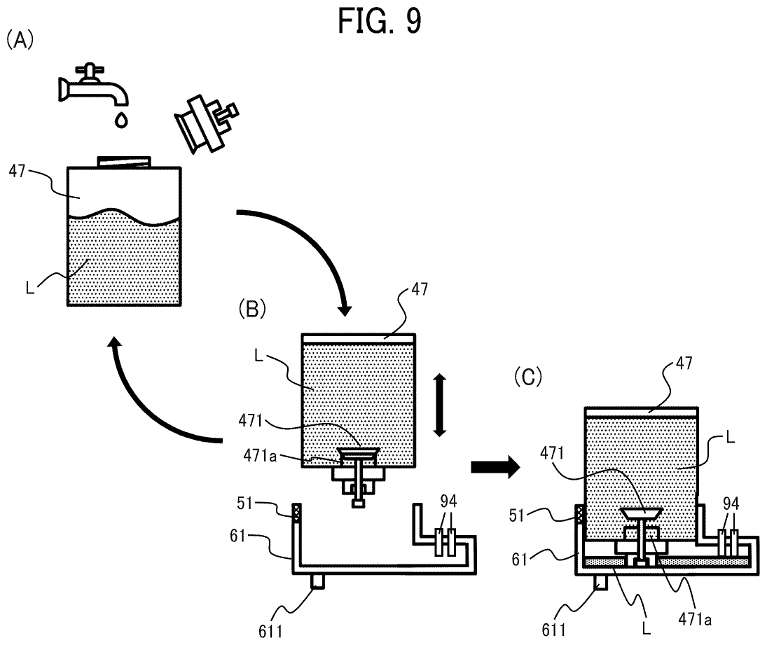

The edge binder 25 or the post-processing apparatus 3 is provided with the second liquid storage tank 47. The second liquid storage tank 47 is attachable to and detachable from the second-liquid-storage-tank fixer 61 (a part of the second liquid storage) disposed in the edge binder 25 or the post-processing apparatus 3 (see FIG. 9). The second liquid storage tank 47 is fixed (or set) to the second-liquid-storage-tank fixer 61 (a part of the second liquid storage unit) at a given position. Thus, the liquid already stored in the second liquid storage tank 47 can be supplied to the first liquid storage tank 44.

The operation of supplying liquid from the second liquid storage tank 47 to the first liquid storage tank 44 by the liquid supply pump 46 is executed in response to a decrease in the stored liquid amount (liquid level) in the first liquid storage tank 44. The stored liquid amount (liquid level) of the first liquid storage tank 44 is reduced by the liquid being consumed by liquid application by the liquid applier 31. In other words, the operation of supplying liquid from the second liquid storage tank 47 to the first liquid storage tank 44 corresponds to the liquid supply operation in accordance with the execution of the job including liquid application by the liquid applier 31.

This liquid supply operation corresponds to an operation of supplying liquid to the first liquid storage tank 44 so as to replenish liquid each time the stored liquid amount (liquid level) of the first liquid storage tank 44 falls below a reference liquid level, which is described below.

When the second liquid storage tank 47 is set in the second-liquid-storage-tank fixer 61, the second-liquid-storage-tank fixer 61 is filled with a certain amount of the liquid in the second liquid storage tank 47. The second-liquid-storage-tank fixer 61 includes a setting detection sensor 51 (an example of a set detector) (see FIG. 9). When the setting detection sensor 51 detects the set state of the second liquid storage tank 47 to the second-liquid-storage-tank fixer 61 (see part (C) of FIG. 9), a signal indicating the set state is transmitted to the controller 100b, which is described below. Thus, the controller 100b, which is described below, detects whether the second liquid storage tank 47 is mounted on the second-liquid-storage-tank fixer 61. Details of the second liquid storage tank 47 will be described below.

The first liquid storage tank 44 and the second liquid storage tank 47 are coupled to each other by the liquid supply passage 45. The liquid supply pump 46 is disposed near the second-liquid-storage-tank fixer 61. As the liquid supply pump 46 is driven, the liquid stored in the second liquid storage tank 47 is supplied (replenished) from the second liquid storage tank 47 to the first liquid storage tank 44 via the liquid supply passage 45. Accordingly, the second-liquid-storage-tank fixer 61 is a component of the liquid supplier that executes a liquid supply operation to supply liquid from the second liquid storage tank 47 to the first liquid storage tank 44. The liquid supply passage 45 includes a flexible material. According to such a configuration, even if the first liquid storage tank 44 is moved by the liquid-applier movement assembly 35, liquid can be supplied from the second liquid storage tank 47 to the first liquid storage tank 44.

The supply of liquid from the second liquid storage tank 47 to the first liquid storage tank 44 can be controlled in accordance with the detection result of the first liquid-level sensor 43. In other words, the controller 100b, which is described below, determines the position (liquid level) of the liquid surface of the liquid that is stored in the first liquid storage tank 44 in order to determine the amount of liquid (stored liquid amount) stored in the first liquid storage tank 44 based on the detection result of the first liquid-level sensor 43. In accordance with the determined stored liquid amount (liquid level) of the first liquid storage tank 44, the controller 100b controls the operation speed and time of the liquid supply pump 46. By so doing, the controller 100b can adjust the amount of liquid to be replenished to the first liquid storage tank 44 to maintain the stored liquid amount (liquid level) in the first liquid storage tank 44 at a constant level of liquid.

A description is given below of the configuration of the crimper 32.

As illustrated in FIG. 3, the crimper 32 as a post-processing device presses and deforms at least a portion (liquid application position) of the sheet bundle Pb, to which liquid has been applied by the liquid applier 31, by serrated upper crimping teeth 32a and lower crimping teeth 32b, and crimps the sheets P of the portion to bind the sheet bundle Pb. In other words, the crimper 32 can bind the sheet bundle Pb without using staples. The components of the crimper 32 such as the upper crimping teeth 32a and the lower crimping teeth 32b are disposed on a crimping frame 32c. In the following description, such a way of pressing and deforming a given position on the sheet bundle Pb to bind the sheet bundle Pb may be referred to as “crimp binding.” In other words, the crimper 32 crimps and binds the sheet bundle Pb or performs the crimp binding on the sheet bundle Pb. The crimping and binding operation of the crimper 32 that involves control processing is referred to as “crimp binding process.”

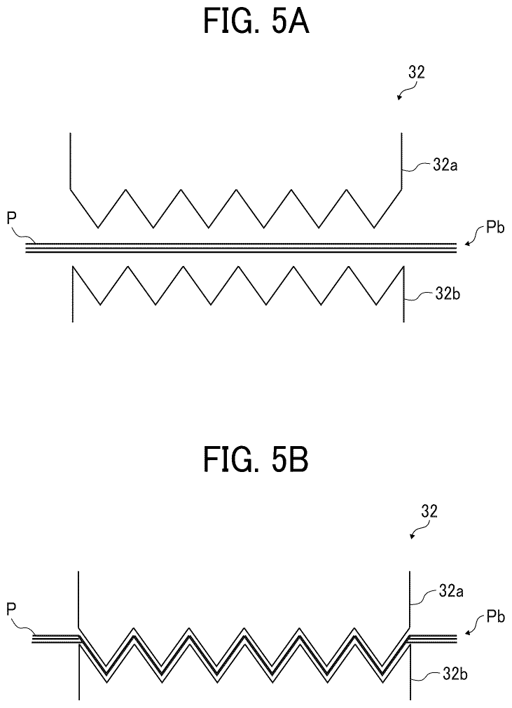

FIGS. 5A and 5B are schematic diagrams illustrating the configuration of the crimper 32. As illustrated in FIGS. 5A and 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb to sandwich the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b such that the upper crimping teeth 32a are engaged with the lower crimping teeth 32b. The upper crimping teeth 32a and the lower crimping teeth 32b are brought into contact with and separated from each other by the driving force of a contact-separation motor 32d illustrated in FIG. 10.

In the process of supplying the sheets P of the sheet bundle Pb to the internal tray 22, the upper crimping teeth 32a and the lower crimping teeth 32b are separated from each other as illustrated in FIG. 5A. When all the sheets P of the sheet bundle Pb are placed on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. As a result, the sheet bundle Pb that has been placed on the internal tray 22 is crimped and bound. The sheet bundle Pb thus crimped and bound is ejected to the second ejection tray 26 by the conveyance roller pair 15.

The configuration of the crimper 32 as a crimping assembly is not limited to the configuration of a moving assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or that rotates the forward and backward directions (e.g., the crimping assembly disclosed in Japanese Patent No. 6057167). Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the edge binder 25 includes an edge-binder movement assembly 57. The edge-binder movement assembly 57 moves the edge binder 25 (in other words, the liquid applier 31 and the crimper 32) in the main scanning direction along the downstream end of the sheet P, which is placed on the internal tray 22, in the conveyance direction. The edge-binder movement assembly 57 includes, for example, the base 48, a guide shaft 49, the edge-binder movement motor 55, and a driving force transmission assembly 551 that transmits the driving force of the edge-binder movement motor 55 to the base 48, and a standby position sensor 540 (see FIG. 10).

The liquid applier 31 and the crimper 32 are attached to the base 48 such that the liquid applier 31 and the crimper 32 are adjacent to each other in the main scanning direction. As illustrated in FIG. 4, the guide shaft 49 is held by multiple guide shaft brackets 49a disposed in the main scanning direction at a position on the upstream side of a binding assembly base 116 in the conveyance direction of the sheet P. As illustrated in FIG. 3, the guide shaft 49 extends in the main scanning direction on the binding assembly base 116. The guide rail 115 is disposed in the main scanning direction on the downstream side of the binding assembly base 116 in the conveyance direction of the sheet P. As illustrated in FIG. 4, the guide rail 115 includes a fitting target portion 115a that fits to a fitting portion 48a of the base 48 in the main scanning direction. In other words, the base 48 is movably held by the guide shaft 49 and the guide rail 115 in the main scanning direction on the binding assembly base 116.

The edge-binder movement motor 55 generates a driving force to move the edge binder 25. The driving force transmission assembly 551 transmits the driving force of the edge-binder movement motor 55 to the base 48 via pulleys 551a and 551b, a timing belt 551c, and a fastening portion 48b that fastens the base 48 and the timing belt 551c. As a result, the liquid applier 31 and the crimper 32 integrated by the base 48 move in the main scanning direction along the guide shaft 49.

The edge-binder movement motor 55 according to the present embodiment is, for example, a servo motor that can stop the edge binder 25 at a target position (for example, the first binding position B1 and a second binding position B2 described below) without returning the edge binder 25 to an origin position (for example, a standby position HP described below) each time the edge binder 25 is moved.

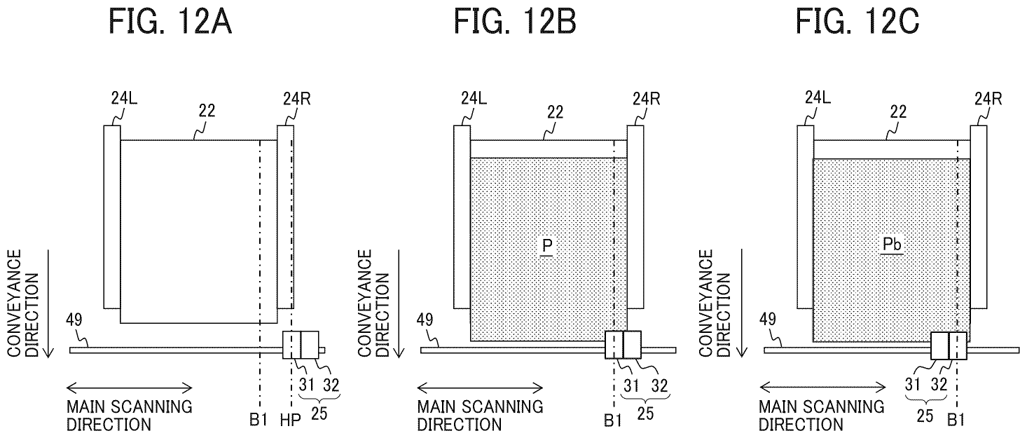

The post-processing apparatus 3 further includes a standby position sensor 540 and an encoder sensor 541. The standby position sensor 540 is, for example, a light-shielding optical sensor (see FIG. 10) to detect that the edge binder 25 has reached a standby position HP (see FIG. 12A). The encoder sensor 541 (see FIG. 10) is attached to an output shaft of the edge-binder movement motor 55. The controller 100b, which is described below, detects that the edge binder 25 has reached the standby position HP, based on a detection result of the standby position sensor 540. The controller 100b also counts pulse signals output from the encoder sensor 541 to ascertain the current position of the edge binder 25 moved from the standby position HP.

However, a specific method of stopping the edge binder 25 at the target position without returning the edge binder 25 to the standby position HP is not limited to the aforementioned example. As another example, the post-processing apparatus 3 may include a sensor that detects that the edge binder 25 has reached a predetermined target position.

As illustrated in FIG. 3, a crimper shaft 54 provided with a drive transmission gear 54a is fixed to a bottom face of the crimping frame 32c that holds the components of the crimper 32. The crimper shaft 54 and the drive transmission gear 54a are held by the base 48 on which the crimping frame 32c is disposed, so as to be rotatable in the forward and reverse directions. The drive transmission gear 54a meshes with an output gear 56a of a crimper pivot motor 56. The crimper 32 can be rotated in the forward and reverse directions about the crimper shaft 54 on the base 48 by a driving force transmitted from the crimper pivot motor 56 to the crimper shaft 54 via the output gear 56a and the drive transmission gear 54a.

In the above description, the edge binder 25 has a configuration of moving along the guide shaft 49 with the crimper 32 and the liquid applier 31 being integrated, the embodiments of the present disclosure are not limited to the above-described configuration. For example, the crimper 32 and the liquid applier 31 may have a configuration of moving separately from each other.

A description is given below of the staple binder 155.

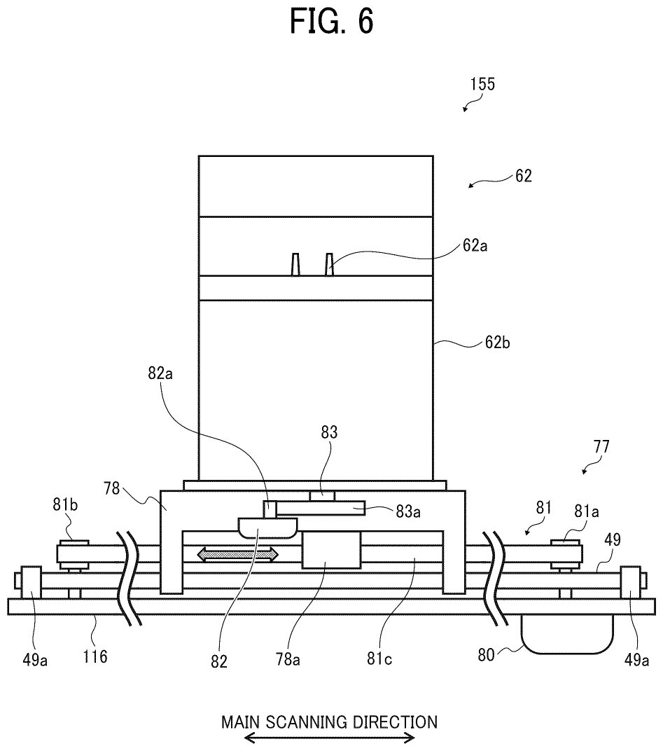

Specifically, a detailed description is given below of the staple binder 155 having a function of executing a stapling process. FIG. 6 is a schematic diagram illustrating the staple binder 155, viewed from the upstream side of the staple binder 155 in the conveyance direction. The staple binder 155 includes a stapler 62 that binds the sheet bundle Pb with staples. The stapler 62 is disposed downstream from the internal tray 22 in the conveyance direction and spaced apart from the edge binder 25 in the main scanning direction.

The stapler 62, which is an example of a post-processing device, has a configuration of performing so-called “stapling” (i.e., stapling process) to bind the sheet bundle Pb with a staple or staples. More specifically, the stapler 62 includes a stapling-part drive motor 62d illustrated in FIG. 10. The stapling-part drive motor 62d drives a stapling part 62a. The driving force of the stapling-part drive motor 62d causes a staple loaded in the stapling part 62a to insert through a sheet bundle Pb, so that the stapling part 62a binds the sheet bundle Pb. Since the stapler 62 has a typical configuration, a detailed description thereof will be omitted unless otherwise required.

As illustrated in FIG. 6, the staple binder 155 includes a staple binder movement assembly 77. The staple binder movement assembly 77 moves the staple binder 155 in the main scanning direction along a downstream end in the conveyance direction of the sheet P or the sheet bundle Pb placed on the internal tray 22. The staple binder movement assembly 77 includes, for example, a base 78, the guide shaft 49, a staple binder movement motor 80, and a driving force transmission assembly 81. The driving force transmission assembly 81 transmits a driving force of the staple binder movement motor 80 to the base 78 via pulleys 81a and 81b, a timing belt 81c, and a fastening portion 78a that fastens the base 78 and the timing belt 81c. A stapler shaft 83 including a drive transmission gear 83a is fixed to a bottom face of a stapling frame 62b that holds the components of the stapler 62.

The stapler shaft 83 and the drive transmission gear 83a are held by the base 78 on which the stapling frame 62b is disposed, so as to be rotatable in the forward and reverse directions. The drive transmission gear 83a is engaged with an output gear 82a of the stapler pivot motor 82. The stapler 62 can be rotated in the forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the staple binder 155 are supported by the common guide shaft 49. In other words, the edge-binder movement assembly 57 and the staple binder movement assembly 77 move the edge binder 25 and the staple binder 155 in the main scanning direction along the common guide shaft 49. The edge-binder movement assembly 57 and the staple binder movement assembly 77 can independently move the edge binder 25 and the staple binder 155.

A description is given below of a modification of the staple binder 155.

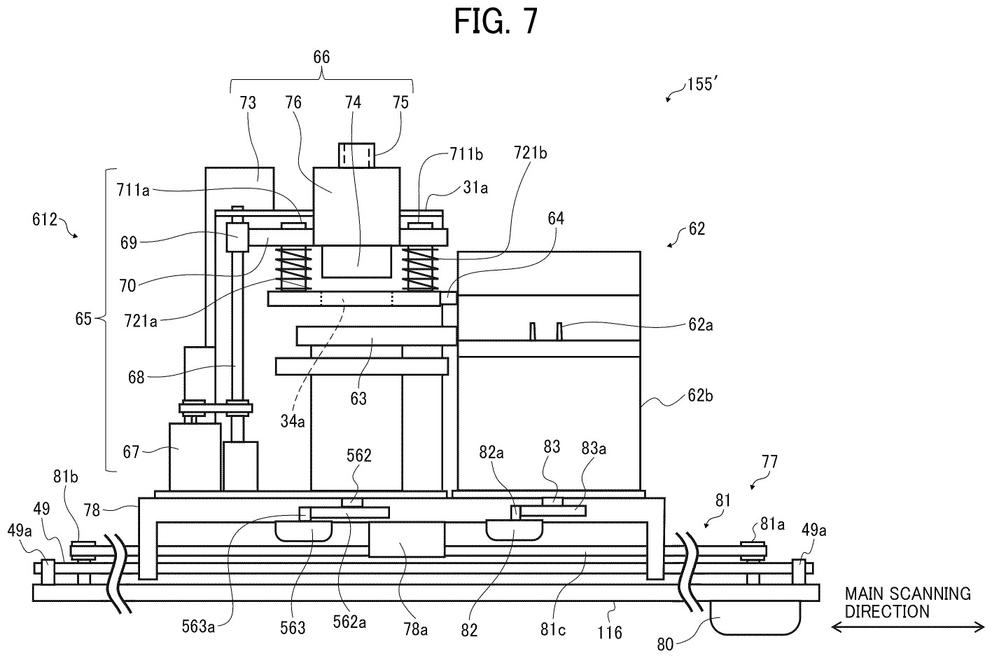

FIG. 7 illustrates a staple binder 155′ as a modification of the staple binder 155. More specifically, FIG. 7 is a schematic diagram illustrating the staple binder 155′ viewed from the upstream side thereof in the conveyance direction. The staple binder 155′ is different from the staple binder 155 in that the staple binder 155′ includes a second liquid applier 612 in addition to the stapler 62. As illustrated in FIG. 7, the staple binder 155′ includes the second liquid applier 612 and the stapler 62. The second liquid applier 612 and the stapler 62 are disposed downstream from the internal tray 22 in the conveyance direction and adjacent to each other in the main scanning direction.

The second liquid applier 612 executes liquid application of applying liquid stored in a third liquid storage tank 73 to the sheet P or the sheet bundle Pb placed on the internal tray 22. A given area including a position to which the liquid is applied on the sheet P or the sheet bundle Pb by the second liquid applier 612 corresponds to a binding position to be stapled by the stapler 62. As illustrated in FIG. 7, the second liquid applier 612 includes a second lower pressure plate 63, a second upper pressure plate 64, a second liquid-applier movement assembly 65, and a second liquid application assembly 66. The second liquid-applier movement assembly 65 includes, for example, a second liquid-application-unit movement motor 67, a second trapezoidal screw 68, a second nut 69, a second base plate 70, second columns 711a and 711b, and second coil springs 721a and 721b.

The second liquid application assembly 66 includes the third liquid storage tank 73, a second liquid supply portion 75, a second liquid application member 74, and a second joint 76. Since the second liquid application assembly 66 and the liquid application assembly of the liquid applier 31 (including the first liquid storage tank 44, the liquid supply member 50, the liquid application member 501, and the holder 37) illustrated in FIGS. 3 and 4 have common configurations, redundant descriptions thereof will be omitted unless otherwise required. Since the configuration of the stapler 62 illustrated in FIG. 6 is like the configuration of the stapler 62 illustrated in FIG. 7, a detailed description thereof is omitted below unless otherwise required. Since the second liquid applier 612 and the liquid applier 31 that are illustrated in FIG. 3 have common pivot mechanisms, redundant descriptions thereof will be omitted unless otherwise required. The pivot mechanism of the second liquid applier 612 includes a liquid-applier pivot motor 563, an output gear 563a, drive transmission gear 562a, and a liquid applier shaft 562.

As with the staple binder 155′ illustrated in FIG. 7, when the liquid application is also performed on the sheet P in the stapling process, the binding position is loosened and softened, thus allowing the staple to easily pass through. As a result, the number of sheets to be bound per sheet bundle Pb can be increased as compared with a case where the stapling process is performed without performing the liquid application.

A detailed description is given below of the second liquid storage tank 47.

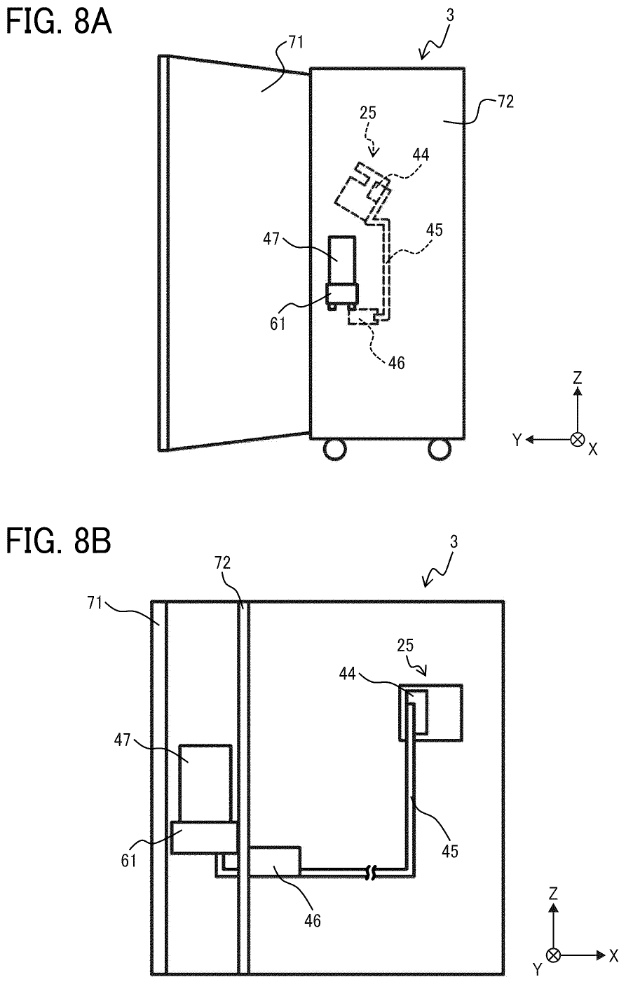

Referring to FIGS. 8A, 8B, and 9, a description is given below of the arrangement and configuration of the second liquid storage tank 47 in the post-processing apparatus 3. FIGS. 8A and 8B illustrate example location and configuration of the second liquid storage tank 47 as the main tank. FIG. 8A illustrates the post-processing apparatus 3 with a cover 71 opened. FIG. 8B is a sectional side view of the post-processing apparatus 3, illustrating the post-processing apparatus 3 with the cover 71 closed. As illustrated in FIG. 8A, the second liquid storage tank 47 is located so as to be accessible when the cover 71 of the post-processing apparatus 3 is opened. As illustrated in FIG. 8B, the second liquid storage tank 47 and the second-liquid-storage-tank fixer 61 are disposed on the near side in a depth direction (X direction) of the post-processing apparatus 3. The first liquid storage tank 44 is disposed on the far side in the depth direction (X direction) of the post-processing apparatus 3. A housing side plate 72 of the post-processing apparatus 3 is disposed between the arrangement position of the second liquid storage tank 47 and the second-liquid-storage-tank fixer 61 and the arrangement position of the first liquid storage tank 44. The second-liquid-storage-tank fixer 61 is attached to the housing side plate 72 of the post-processing apparatus 3.

FIG. 9 illustrates the second liquid storage tank 47 attachable to and detachable from the second-liquid-storage-tank fixer 61 and a state where liquid is replenished to the second liquid storage tank 47. As illustrated in part (A) of FIG. 9, the second liquid storage tank 47 is detachably attached to the first liquid storage tank 44 so that the second liquid storage tank 47 can replenish the liquid to the first liquid storage tank 44. As illustrated in part (B) of FIG. 9, the second-liquid-storage-tank fixer 61 is provided with the setting detection sensor 51, which is an example of a setting detector, to detect that the second liquid storage tank 47 is set on the second-liquid-storage-tank fixer 61.

When the setting detection sensor 51 detects the set state of the second liquid storage tank 47 to the second-liquid-storage-tank fixer 61 (see part (C) of FIG. 9), a signal indicating the set state is transmitted to the controller 100b. Thus, the controller 100b detects whether the second liquid storage tank 47 is set on the second-liquid-storage-tank fixer 61.

The second liquid-level sensor 94 (which is an example of second liquid detector) that detects the amount of liquid L to be stored in the second liquid storage tank 47 is disposed in the second-liquid-storage-tank fixer 61. The output value (voltage) of the second liquid-level sensor 94 is notified to the controller 100b. The controller 100b determines the output value (voltage) of the second liquid-level sensor 94 to determine whether the amount of liquid stored in the second-liquid-storage-tank fixer 61 is a required amount of liquid. When the controller 100b determines that the second liquid storage tank 47 is set on the second-liquid-storage-tank fixer 61 (i.e., is in a set state) based on the output signal of the setting detection sensor 51, the controller 100b turns on the second liquid-level sensor 94 such that the remaining amount of liquid (the amount of the liquid stored) in the second-liquid-storage-tank fixer 61 can be detected.

When the second liquid storage tank 47 is not set on the second-liquid-storage-tank fixer 61 (i.e., is in a non-set state), a liquid discharge port 471a of the second liquid storage tank 47 is closed by a liquid supply valve 471 so that liquid L does not leak. As illustrated in part (C) of FIG. 9, when the second liquid storage tank 47 is set to the second-liquid-storage-tank fixer 61, the liquid supply valve 471 is pushed up to open a liquid discharge port 471a of the second liquid storage tank 47. By so doing, the liquid Lis flow out from the second liquid storage tank 47 to the second-liquid-storage-tank fixer 61. As a result, the liquid L stored in the second liquid storage tank 47 flows out to the second-liquid-storage-tank fixer 61. The liquid L flown from the second liquid storage tank 47 is temporarily stored in the second-liquid-storage-tank fixer 61.

As a measurement to prevent liquid L from being frozen during maintenance of the post-processing apparatus 3, a liquid draining process may be performed to drain the liquid L in the post-processing apparatus 3. In the liquid draining process, the liquid L remaining in the first liquid storage tank 44 and the liquid supply passage 45 is supplied by the liquid supply pump 46 to the second-liquid-storage-tank fixer 61 via the liquid supply passage 45 in the reverse direction. In order to deal with such a situation, the second-liquid-storage-tank fixer 61 is set to the amount to sufficiently store liquid in the first liquid storage tank 44 and the liquid supply passage 45. As illustrated in parts (B) and (C) of FIG. 9, the second-liquid-storage-tank fixer 61 is provided with a liquid drain plug 611. After the liquid L remaining in the first liquid storage tank 44 and the liquid supply passage 45 is reversely fed by the liquid supply pump 46 to the second-liquid-storage-tank fixer 61, the liquid drain plug 611 is opened to discharge the liquid L stored in the second-liquid-storage-tank fixer 61 from the inside of the post-processing apparatus 3.

A description is given below of control blocks of the post-processing apparatus 3 with reference to FIG. 10. FIG. 10 is a block diagram illustrating a hardware configuration for executing control processing in the post-processing apparatus 3. As illustrated in FIG. 10, the post-processing apparatus 3 includes a central processing unit (CPU) 101, a random-access memory (RAM) 102, a read-only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic device and controls the overall operation of the post-processing apparatus 3. The RAM 102 is a volatile storage medium that allows high speed reading and writing of data, and is used as a working area when the CPU 101 processes information. The ROM 103 is a read-only non-volatile storage medium, and stores programs such as firmware. The HDD 104 is a non-volatile storage medium that allows data to be read and written and has a relatively large storage capacity. The HDD 104 stores, for example, an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the I/F 105 constitute at least part of a controller 100b, which is an example of a control device, to control the operation of the post-processing apparatus 3.

The I/F 105 is an interface that connects the conveyance roller pairs 10, 11, 14, and 15, the switching member 20, the side fences 24L and 24R, the contact-separation motor 32d, the crimper pivot motor 56, the liquid-application-unit movement motor 42, the liquid-applier pivot motor 563, the edge-binder movement motor 55, the stapling-part drive motor 62d, the stapler pivot motor 82, the staple binder movement motor 80, the liquid supply pump 46, the movement sensor 40a, the first liquid-level sensor 43, the second liquid-level sensor 94 serving as a second liquid amount detector, the setting detection sensor 51, the standby position sensor 540, the encoder sensor 541, and an operation panel 110 to the common bus 109.

The controller 100b controls, via the I/F 105, the operations of the conveyance roller pairs 10, 11, 14, and 15, the switching member 20, the side fences 24L and 24R, the contact-separation motor 32d, the crimper pivot motor 56, the liquid-application-unit movement motor 42, the liquid-applier pivot motor 563, the edge-binder movement motor 55, the stapling-part drive motor 62d, the stapler pivot motor 82, the staple binder movement motor 80, and the liquid supply pump 46. The controller 100b acquires detection results from the movement sensor 40a, the first liquid-level sensor 43, the second liquid-level sensor 94, the setting detection sensor 51, the standby position sensor 540, and the encoder sensor 541. Although FIG. 10 illustrates only the components related to the edge binder 25 and the staple binder 155 that perform the edge binding, the components related to the saddle binder 28 that performs the saddle binding are also controlled by the controller 100b.

As illustrated in FIG. 1, the image forming apparatus 2 includes the operation panel 110. The operation panel 110 includes an operation section that receives instructions input by an operator and a display (which is an example of a notifier) that notifies the operator of information. The operation section includes, for example, hard keys and a touch screen overlaid on the display. The operation panel 110 acquires information from the user through the operation section and provides information to the user through the display. A specific example of the notifier is not limited to the display and may be a light-emitting diode (LED) lamp or a speaker. The post-processing apparatus 3 may include an operation panel 110 similar to the above-described operation panel 110 of the image forming apparatus 2.

As described above, the post-processing apparatus 3 implements the function of performing operation control related to the liquid application by software (control programs) executed by the CPU 101 with hardware resources included in the controller 100b.

The liquid application performed by the post-processing apparatus 3 may be performed in a form in which the staple binder 155 is provided with only the stapler 62 and the liquid application is performed using the liquid applier 31 of the edge binder 25. Conversely, the edge binder 25 may include only the crimper 32, and the liquid application may be performed in a mode in which the second liquid applier 612 is used. In other words, the post-processing apparatus 3 may have a configuration in which only one of the liquid applier 31 and the second liquid applier 612 performs the liquid application, regardless of the type of the binding process.

In the above description, the staple binder 155′ has a configuration of moving along the guide shaft 49 with the stapler 62 and the second liquid applier 612 being integrated, the embodiments of the present disclosure are not limited to the above-described configuration. For example, the stapler 62 and the second liquid applier 612 may have a configuration of moving separately from each other.

A description is given below of a binding process.

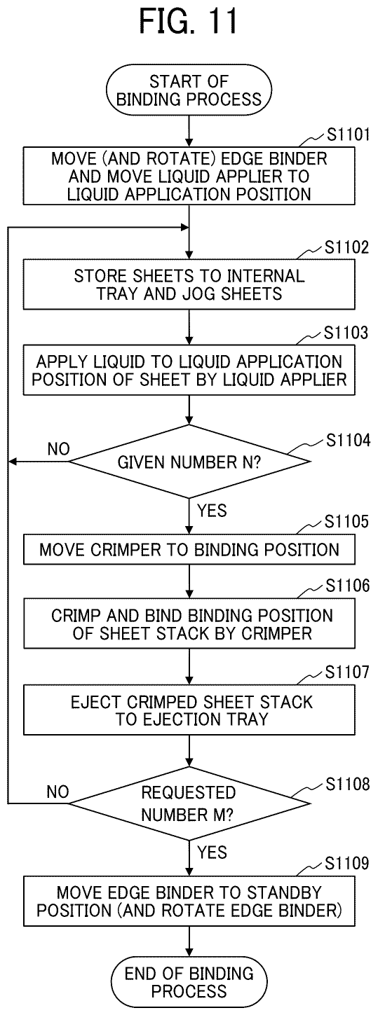

Specifically, a description is given below of a binding process executed by the edge binder 25 included in the post-processing apparatus 3. FIG. 11 is a flowchart of a process of one-point binding performed by the edge binder 25. FIGS. 12A, 12B, and 12C are diagrams illustrating the positions of the edge binder 25 (the liquid applier 31 and the crimper 32) during the one-point binding. In FIGS. 12A, 12B, and 12C, the changes in the postures of the liquid applier 31 and the crimper 32 are not illustrated. The position (liquid application position) on a sheet P or a sheet bundle Pb onto which the liquid application is performed by the liquid applier 31 corresponds to the binding position on the sheet bundle Pb to be crimped by the crimper 32. For this reason, in the following description, the liquid application position and the binding position are denoted by the same reference sign (B1 or B2).

For example, the controller 100b starts the binding process illustrated in FIG. 11 when the controller 100b acquires an instruction to execute the binding process from the image forming apparatus 2. In the following description, the instruction to execute the binding process may be referred to as a “binding command.”

The binding command includes, for example, the type of the sheet P (i.e., information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number of sheets N” whereas the number of sheet bundles Pb to be bound may be referred to as “requested number of copies M.” The liquid applier 31 and the crimper 32 are assumed to be in a parallel binding posture and located at a standby position HP that is a position away in the width direction from the sheets P placed on the internal tray 22 at the start of the binding process as illustrated in FIG. 12A.

When the posture that is instructed by the binding command is the “inclined binding posture,” in step S1101, the controller 100b drives the liquid-applier pivot motor 563 and the crimper pivot motor 56 to rotate the liquid applier 31 and the crimper 32 of the edge binder 25 into the inclined binding posture. Alternatively, when the posture that is instructed by the binding command is the “inclined binding posture,” the crimper 32 alone may be rotated to the inclined binding posture while the liquid applier 31 may not be rotated. As a result, the driving assembly may be simplified as compared with a case where both the liquid applier 31 and the crimper 32 are rotated in the forward and reverse directions, and thus effects of cost reduction, downsizing of the apparatus, and reduction of failure of the device are exhibited.

On the other hand, when the posture that is instructed by the binding command is the “parallel binding posture,” the controller 100b omits the aforementioned operation of rotating the liquid applier 31 and the crimper 32 of the edge binder 25 to the inclined binding posture.

In step S1101, the controller 100b drives the edge-binder movement motor 55 to move the edge binder 25 in the main scanning direction so that the liquid applier 31 faces the first liquid application position B1 instructed by the binding command. The controller 100b executes the operation of step S1101 before a first sheet P is conveyed to the internal tray 22 by the conveyance roller pairs 10, 11, 14, and 15.

In step S1102, the controller 100b rotates the conveyance roller pairs 10, 11, 14, and 15 to store the sheet P, on which the image has been formed by the image forming apparatus 2, onto the internal tray 22. In step S1102, the controller 100b also moves the side fences 24L and 24R to align the position of the sheet P or the sheet bundle Pb placed on the internal tray 22 in the main scanning direction. In short, the controller 100b performs so-called jogging.

In step S1103, the controller 100b causes the liquid applier 31 facing the first liquid application position B1 to apply liquid to the first liquid application position B1 of the sheet P placed on the internal tray 22 in the immediately preceding step S1102, based on the liquid application control data adjusted in advance. In other words, the controller 100b drives the liquid-application-unit movement motor 42 to bring the liquid application member 501 into contact with the liquid application position B1 on the sheet P placed on the internal tray 22 (see FIG. 12B). In the liquid application process in step S1103, the controller 100b adjusts the position at which the liquid application member 501 applies liquid to the sheet Pin accordance with the type of the sheet P and the binding position included in the binding command. The controller 100b adjusts the amount of pressing the liquid application member 501 against the sheet P. In other words, the controller 100b controls the driving of the liquid-application-unit movement motor 42 based on the adjusted control data, and adjusts the amount of movement of the liquid application member 501 with respect to the first liquid application position B1 of the sheet P placed on the internal tray 22.

In step S1104, the controller 100b determines whether the number of sheets P placed on the internal tray 22 has reached the given number of sheets N instructed by the binding command. When the controller 100b determines that the number of sheets P placed on the internal tray 22 has not reached the given number of sheets N (NO in step S1104), the controller 100b executes the operations of steps S1102 to S1104 again until the number of sheets P placed on the internal tray 22 reaches the given number of sheets N (YES in step S1104). In other words, the controller 100b executes the processing of steps S1102 to S1104 each time the sheet P is conveyed to the internal tray 22 by the conveyance roller pairs 10, 11, 14, and 15. The liquid application by the liquid applier 31 may be performed on each of the sheets P of the sheet bundle Pb.

When the controller 100b determines that the number of sheets P placed on the internal tray 22 has reached the given number of sheets N (YES in step S1104), in step S1105, the controller 100b drives the edge-binder movement motor 55 to move the edge binder 25 in the main scanning direction such that the crimper 32 faces the first binding position B1 as illustrated in FIG. 12C.

In step S1106, the controller 100b causes the crimper 32 to crimp the sheet bundle Pb placed on the internal tray 22. In step S1107, the controller 100b causes the conveyance roller pair 15 to eject the sheet bundle Pb thus crimped and bound by the crimper 32 to the second ejection tray 26. Specifically, the controller 100b drives the contact-separation motor 32d to cause the upper crimping teeth 32a and the lower crimping teeth 32b to pinch the first binding position B1 on the sheet bundle Pb placed on the internal tray 22. The sheet bundle Pb is pressed and deformed between the upper crimping teeth 32a and the lower crimping teeth 32b, and thus the sheet bundle Pb is crimped. Then, the controller 100b rotates the conveyance roller pair 15 to eject the sheet bundle Pb thus crimped and bound to the second ejection tray 26.

The sheet bundle Pb that is supported on the internal tray 22 has a crimping area (corresponding to the first binding position B1) sandwiched between the upper crimping teeth 32a and the lower crimping teeth 32b in step S1106. The crimping area overlaps a liquid application area (corresponding to the first liquid application position B1) contacted by the end of the liquid application member 501 in step S1103. In other words, the crimper 32 crimps an area to which liquid is applied by the liquid applier 31 on the sheet bundle Pb placed on the internal tray 22. The crimping area that is pinched by the upper crimping teeth 32a and the lower crimping teeth 32b may completely or partially overlaps the liquid application area contacted by the distal end (tip portion) of the liquid application member 501, to obtain a sufficient binding strength.

In step S1108, the controller 100b determines whether the number of sheet bundles Pb thus ejected to the second ejection tray 26 has reached the requested number of copies M indicated by the binding command. When the controller 100b determines that the number of sheet bundles Pb thus ejected has not reached the requested number of copies M (NO in step S1108), the controller 100b executes the operations of step S1102 and subsequent steps again. In other words, when the controller 100b determines that the number of sheet bundles Pb thus ejected has not reached the requested number of copies M (NO in step S1108), the controller 100b repeats the operations of steps S1102 to S1108 until the number of sheet bundles Pb ejected to the second ejection tray 26 reaches the requested number of copies M.

On the other hand, when the controller 100b determines that the number of sheet bundles Pb output to the second ejection tray 26 has reached the requested number of copies M (YES in step S1108), in step S1109, the controller 100b drives the edge-binder movement motor 55 to move the edge binder 25 (the liquid applier 31 and the crimper 32) to the standby position HP as illustrated in FIG. 12A. When the posture that is instructed by the binding command is the “oblique binding posture,” in step S1109, the controller 100b also drives the liquid-applier pivot motor 563 and the crimper pivot motor 56 to rotate the liquid applier 31 and the crimper 32 into the parallel binding posture. On the other hand, when the posture that is instructed by the binding command is the “parallel binding posture,” the controller 100b skips the aforementioned operation of rotating the liquid applier 31 and the crimper 32 to the parallel binding posture. As a result, the edge binder 25 (the liquid applier 31 and the crimper 32) returns to the standby position HP position illustrated in FIG. 12A. In steps S1101 and S1109, the execution order of the movement in the main scanning direction and the rotation in the forward and reverse directions of the liquid applier 31 and the crimper 32 is not limited to the aforementioned order and may be reversed.

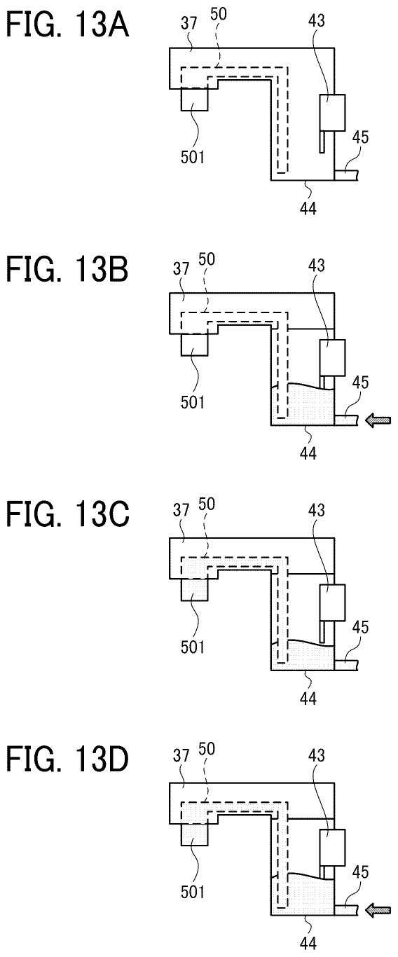

A description is given below of an outline of a filling supply operation that is one of the liquid supply/discharge modes with reference to FIGS. 13A, 13B, 13C, and 13D.

FIG. 13A illustrates an example of an empty state of liquid in the first liquid storage tank 44. From this state, liquid is supplied from the second liquid storage tank 47 to the first liquid storage tank 44 by the liquid supply pump 46 until a state as illustrated in FIG. 13B. At this time, liquid is supplied from the second liquid storage tank 47 to the first liquid storage tank 44 by the liquid supply pump 46 until the first liquid-level sensor 43 detects liquid in the first liquid storage tank 44. A liquid level (an amount of liquid stored in the first liquid storage tank 44) when the first liquid-level sensor 43 detects the liquid in the first liquid storage tank 44 is set as a “reference liquid level.” In other words, the reference liquid level is the position of the liquid level in a state of being detected by the first liquid-level sensor 43.

Then, the liquid stored in the first liquid storage tank 44 is sucked up by the effect of capillary action of the liquid supply member 50. As a result, the level of the liquid stored in the first liquid storage tank 44 decreases to a level lower than the reference liquid level (see FIG. 13C). When the liquid level of the liquid stored in the first liquid storage tank 44 decreases, in order to return the liquid level of the liquid stored in the first liquid storage tank 44 to the reference liquid level, an operation of supplying liquid from the second liquid storage tank 47 to the first liquid storage tank 44 is performed again by the liquid supply pump 46 as necessary (see FIG. 13D). By this series of liquid supply operations, the liquid applier 31 is brought into a state in which the liquid application by the liquid application member 501 is executable.

In the present embodiment, an electrode sensor has been described as an example of the first liquid-level sensor 43, but the first liquid-level sensor 43 is not limited thereto, and other methods may be employed. For example, a float sensor or a capacitance sensor may be used to detect the presence of the liquid. Furthermore, the first liquid-level sensor 43 need only be able to detect the presence of liquid (stored liquid amount) in the first liquid storage tank 44, and is not limited to a sensor that detects the liquid level (surface level) of liquid in the first liquid storage tank 44.

In a case where an electrode sensor is used as the first liquid-level sensor 43, there is a concern that the metal used for the electrodes might be corroded due to electrolytic corrosion if the pair of electrodes is energized (applied with electricity) constantly. Further, since the voltage is always applied to the liquid stored in the first liquid storage tank 44, there is a concern that the liquid might be electrolyzed or that the electrodes might be dissolved due to adhesion of foreign matter to the surface of the electrodes by electrolysis, which might induce deterioration of the electrodes. For this reason, the controller 100b controls the timing of energization of the first liquid-level sensor 43 such that the first liquid-level sensor 43 is not energized all the time but is energized (energized ON) only when the first liquid-level sensor 43 detects whether there is liquid stored at the position of the stored liquid amount (liquid level) of the first liquid storage tank 44.

A description is given below of a control process of the filling supply operation.

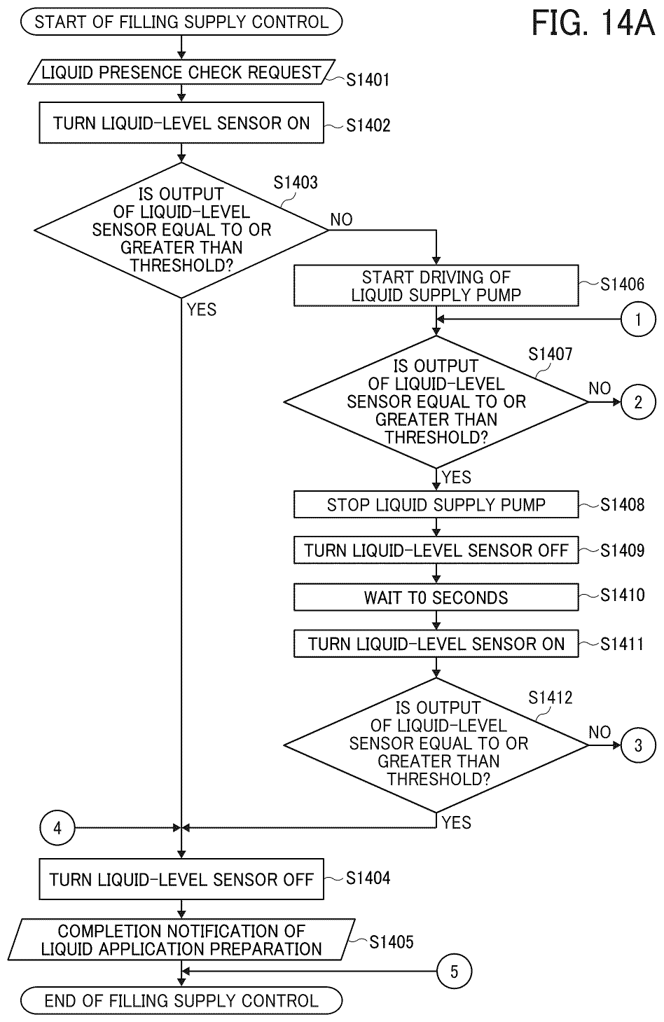

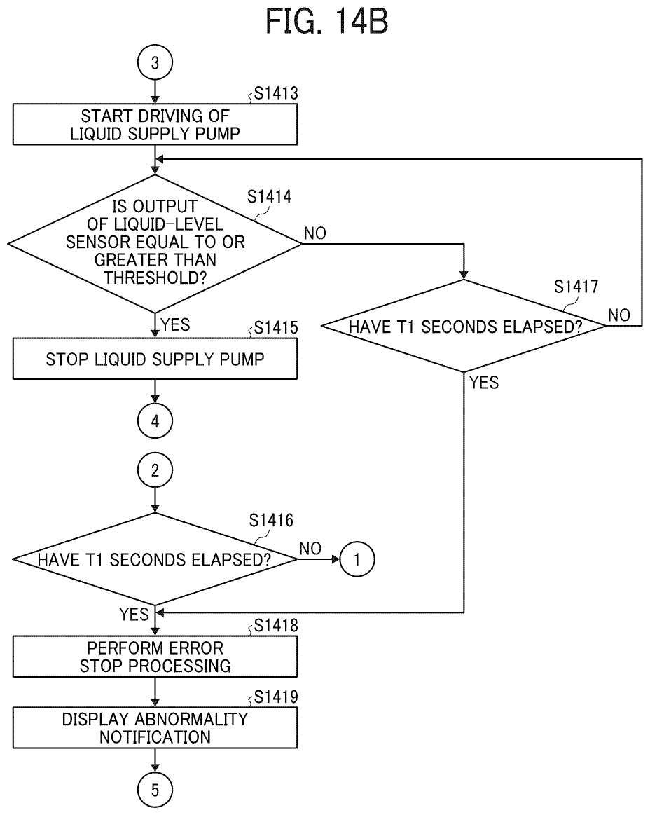

FIG. 14 is a flowchart of a control process of a filling supply operation which is an example of a liquid supply operation executed in the controller 100b. The control process is referred to as a “filling supply control process” in the following description. The filling supply operation is an operation executed at the time of activation of the post-processing apparatus 3 or at the time of start of the crimp binding process involving liquid application, and is an operation distinguished from an additional supply operation executed during the operation of continuously executing liquid application in the post-processing apparatus 3 to continue the sheet bundle Pb until a predetermined number of sheets are obtained.

When the post-processing apparatus 3 is activated, the filling supply control process is started. When the filling supply control process is started, in step S1401, a liquid presence check request is instructed from the image forming apparatus 2 to the controller 100b. The liquid presence check request may be instructed based on the information input by the user through the operation panel 110 of one or both of the image forming apparatus 2 and the post-processing apparatus 3. In response to receipt of the liquid presence check request instructed from the image forming apparatus 2, in step S1402, the controller 100b applies a voltage to the first liquid-level sensor 43 (turns on energization).

In step S1403, the controller 100b acquires an output value (voltage) that the first liquid-level sensor 43 outputs, and determines the presence (the stored liquid amount) of liquid in the first liquid storage tank 44. The determination of the presence of liquid (the stored liquid amount) in the first liquid storage tank 44 is performed based on whether the output value (voltage) from the first liquid-level sensor 43 exceeds a “liquid detection threshold” (threshold) set in advance. For example, when the output value (voltage) from the first liquid-level sensor 43 on the detection of liquid in the first liquid storage tank 44 is equal to or greater than the liquid detection threshold (e.g., the output voltage V1), the controller 100b determines that the amount of liquid stored in the first liquid storage tank 44 is a sufficient amount (YES in step S1403). In this case, the controller 100b stops the application of the voltage to the first liquid-level sensor 43 (turns the energization of the first liquid-level sensor 43 off) in step S1404, displays a completion notification of the preparation for liquid application on, for example, the operation panel 110 in step S1405, and ends the filling supply control process.

Alternatively, in step S1403, when the output value (voltage) from the first liquid-level sensor 43 is less than the liquid detection threshold (e.g., the output voltage V1) (NO in step S1403), in step S1406, the controller 100b operates the liquid supply pump 46 to supply the liquid from the second liquid storage tank 47 to the first liquid storage tank 44.

In step S1407, the controller 100b determines again whether the output value (voltage) from the first liquid-level sensor 43 is equal to or greater than the “liquid detection threshold” (threshold) set in advance. When the output value (voltage) from the first liquid-level sensor 43 is equal to or greater than the liquid detection threshold (e.g., the output voltage V1), the controller 100b determines that a sufficient amount of liquid has been supplied from the second liquid storage tank 47 into the first liquid storage tank 44 by the liquid supply pump 46 (YES in step S1407). On the other hand, when the output value from the first liquid-level sensor 43 is less than the liquid detection threshold (e.g., the output voltage V1) (NO in step S1407), in step S1416, the controller 100b determines whether an elapsed time from the start of the operation of the liquid supply pump 46 (step S1406) has reached an abnormality determination time (T1 seconds (sec)). When the elapsed time from the start of the operation of the liquid supply pump 46 (step S1406) has not reached the abnormality determination time T1 (NO in step S1416), the controller 100b continues the supply of liquid from the second liquid storage tank 47 to the first liquid storage tank 44 by the liquid supply pump 46 until the output value (voltage) from the first liquid-level sensor 43 becomes equal to or greater than the liquid detection threshold (e.g., the output voltage V1) (YES in step S1407).

On the other hand, when the elapsed time from the start of the operation of the liquid supply pump 46 (step S1406) has reached the abnormality determination time T1 (YES in step S1416), the controller 100b determines that some abnormality (such as a failure of the liquid supply pump 46 and/or the first liquid-level sensor 43) has occurred in a device, and performs error stop processing of stopping the liquid supply pump 46 and/or turning off the energization of the first liquid-level sensor 43 in step S1418. In step S1419, the controller 100b causes the operation panel 110 to display an abnormality notification, and ends the filling supply control process.

In step S1407, when the output value (voltage) from the first liquid-level sensor 43 becomes equal to or greater than the liquid detection threshold (e.g., the output voltage V1) (YES in step S1407), in step S1408, the controller 100b stops the liquid supply pump 46 and stops the supply of liquid from the second liquid storage tank 47 to the first liquid storage tank 44. In step S1409, the controller 100b stops the application of voltage to the first liquid-level sensor 43 (i.e., turns off the energization).

The standby time until the liquid in the first liquid storage tank 44 is sucked up by the liquid supply member 50 due to, e.g., the capillary phenomenon and the liquid application member 501 can apply the liquid is set to a “first predetermined time TO (sec)”. In step S1410, the liquid supply control using the liquid supply pump 46 is temporarily stopped until the first predetermined time TO elapses. The “state in which the liquid application member 501 can apply liquid” is a state in which liquid is sufficiently stored in the liquid application member 501 and/or the liquid supply member 50.

After the first predetermined time TO has elapsed, the controller 100b turns on the energization of the first liquid-level sensor 43 again (in step S1411), acquires an output value (voltage) that is output when the first liquid-level sensor 43 detects the liquid in the first liquid storage tank 44, and determines the presence (the stored liquid amount) of liquid in the first liquid storage tank 44 (in step S1412). At this stage, the liquid level (stored liquid amount) of liquid in the first liquid storage tank 44 decreases due to the sucking-up of the liquid supply member 50. However, when the output value (voltage) from the first liquid-level sensor 43 is equal to or greater than the liquid detection threshold (e.g., the output voltage V1) (YES in step S1412), in step S1404, the controller 100b stops the application of the voltage to the first liquid-level sensor 43 (i.e., turns off the energization). In step S1405, the controller 100b displays a completion notification of the preparation for liquid application on, for example, the operation panel 110, and ends the filling supply control process.

Alternatively, in step S1412, when the output value (voltage) from the first liquid-level sensor 43 is less than the liquid detection threshold (e.g., the output voltage V1) (NO in step S1412), in step S1413, the controller 100b operates the liquid supply pump 46 to supply the liquid from the second liquid storage tank 47 to the first liquid storage tank 44.

Subsequently, the controller 100b acquires an output value (voltage) that is output when the first liquid-level sensor 43 detects liquid in the first liquid storage tank 44, and determines the presence (the stored liquid amount) of liquid in the first liquid storage tank 44 in step S1414. When the output value (voltage) from the first liquid-level sensor 43 is equal to or greater than the liquid detection threshold (e.g., the output voltage V1) (YES in step S1414), the controller 100b determines that a sufficient amount of liquid has been supplied into the first liquid storage tank 44. In this case, in step S1415, the controller 100b stops the liquid supply pump 46 to stop the supply of liquid from the second liquid storage tank 47 to the first liquid storage tank 44. Then, the controller 100b stops the application of the voltage to the first liquid-level sensor 43 (i.e., turns the energization of the first liquid-level sensor 43 off) in step S1404, displays a completion notification of the preparation for liquid application on, for example, the operation panel 110 in step S1405, and ends the filling supply control process.

On the other hand, when the output value (voltage) from the first liquid-level sensor 43 is less than the liquid detection threshold (e.g., the output voltage V1) (NO in step S1414), in step S1417, the controller 100b determines whether the elapsed time from the start (step S1413) of the operation of the liquid supply pump 46 has reached the abnormality determination time (T1 seconds). When the elapsed time has not reached the abnormality determination time T1 (NO in step S1417), the controller 100b continues the supply of liquid from the second liquid storage tank 47 to the first liquid storage tank 44 by the liquid supply pump 46 until the output value (voltage) from the first liquid-level sensor 43 becomes equal to or greater than the liquid detection threshold (e.g., the output voltage V1) (YES in step S1414).

On the other hand, when the elapsed time has reached the abnormality determination time T1 (YES in step S1417), the controller 100b determines that some kind of abnormality has occurred in the apparatus, and performs error stop processing of stopping the liquid supply pump 46 and/or turning off the energization of the first liquid-level sensor 43 in step S1418. In step S1419, the controller 100b causes the operation panel 110 to display an abnormality notification, and ends the filling supply control process. The “abnormality notification” may be, for example, a display of a warning on the operation panel 110 to prompt a check because there is a possibility that one or both of the liquid supply pump 46 and the first liquid-level sensor 43 are out of order.

The above-described execution of the filling supply control process allows a constant amount of liquid that enables the liquid application by the liquid application member 501 to be stably ensured for the liquid supply member 50 and/or the liquid application member 501. As a result, the frequency of the liquid supply operation from the second liquid storage tank 47 to the first liquid storage tank 44 by the liquid supply pump 46 can be reduced, and the efficiency of the liquid application process can be enhanced.

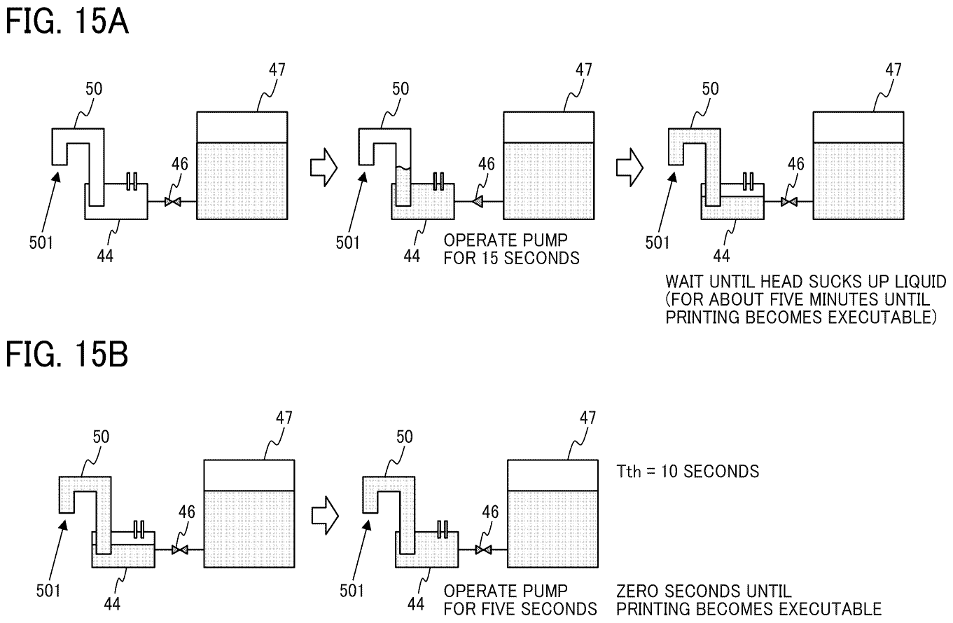

In the following description, among liquid supply controls that can be executed in the post-processing apparatus 3 as a medium processing apparatus according to an embodiment of the present disclosure, a liquid supply control according to an embodiment of the present disclosure is described with reference to the drawings. First, a problem that can be solved by the present embodiment is described with reference to FIGS. 15A and 15B. As in the example illustrated in FIG. 15A, when the first liquid storage tank 44 is empty and the liquid application member 501 is dry, the operation time is assumed to be about 15 seconds when the liquid supply pump 46 is operated until the liquid amount in the first liquid storage tank 44 reaches a predetermined liquid amount (reference liquid level) by supplying the liquid from the second liquid storage tank 47 (an example of a main tank). Then, it is also assumed that, after the liquid level of the first liquid storage tank 44 reaches the reference liquid level, it takes about five minutes for the liquid supply member 50 to suck up the liquid and permeate the liquid application member 501 with the liquid, and cause the liquid application to be executable. This waiting time requires five minutes or more as a transition time from the start of the liquid supply operation to the liquid applicable state. This period is directly correlated to the time until the job of conveying the sheet P to the post-processing apparatus 3 and executing the binding process is executable, and thus the downtime of the entire system is caused.

On the other hand, as in the example illustrated in FIG. 15B, it is assumed that the liquid amount in the first liquid storage tank 44 is at a level sufficient as the liquid amount (liquid level) to the extent that the liquid permeates into the liquid application member 501 by the suction of the liquid supply member 50 and reaches the liquid applicable state. In this case, the operation of supplying the liquid from the second liquid storage tank 47 to the first liquid storage tank 44 using the liquid supply pump 46 may be performed by feeding the liquid to the extent of replenishing the liquid to the reference liquid level, and thus the operation time of the liquid supply pump 46 may be about five seconds. Since the liquid application is already executable, the downtime due to the liquid supply operation does not occur.

As described above, the length of the time (transition time) until the state transitions to the liquid applicable state can be determined based on the liquid level stored in the first liquid storage tank 44 after the liquid-application crimping process is executed by operating the post-processing apparatus 3. In other words, it is possible to determine the presence or absence of the waiting time until the liquid applicable state, based on the liquid level (referred to as an “initial liquid level” in the following description) in the determination of the presence or absence of the liquid supply. However, in the liquid supply control according to a comparative example as described with reference to FIGS. 15A and 15B, the initial liquid level cannot be determined.

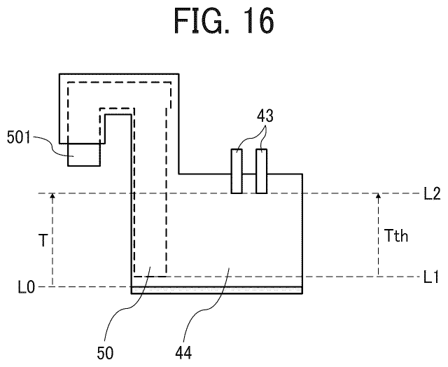

For this reason, in the post-processing apparatus 3 according to the present embodiment, as illustrated in FIG. 16, the position of the lower limit of the liquid level (immersion level) at which an end of the liquid supply member 50 is immersed in the liquid stored in the first liquid storage tank 44 is referred to as a “permeation lower-limit liquid level L1.” The liquid level (reference liquid level) at which the first liquid-level sensor 43 detects liquid is referred to as a “liquid-detection liquid level L2.” Based on these definitions, the time during which the liquid supply operation is performed until the liquid reaches the liquid-detection liquid level L2 from the permeation lower-limit liquid level L1 is set as a “threshold time Tth.” The period of time from the time when the execution of the liquid supply operation is actually started to the time when the liquid reaches the liquid-detection liquid level L2 is referred to as “supplying time T.”

On the premise of these, the liquid supply control is executed by adding the control of comparing the supplying time T with the threshold time Tth. Thus, it is possible to select whether the liquid supply member 50 is permeated with the liquid, that is, whether the “waiting time” until the liquid permeates the liquid application member 501 and the liquid application member 501 reaches the liquid applicable state is necessary. The process of the liquid supply control will be described later.

In the liquid supply control, the supplying time T is measured by using a software timer function executable in the controller 100b.

The threshold time Tth can be calculated based on the amount of liquid from the predetermined permeation lower-limit liquid level L1 to the liquid-detection liquid level L2, which can be derived from the volume of the first liquid storage tank 44, and the liquid supply speed at which the liquid can be supplied by the liquid supply pump 46. The user may input and set any value using the operation panel 110 as necessary.

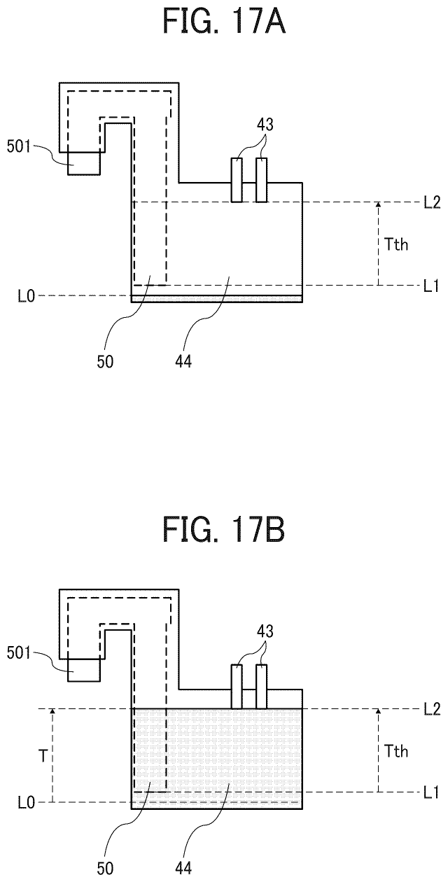

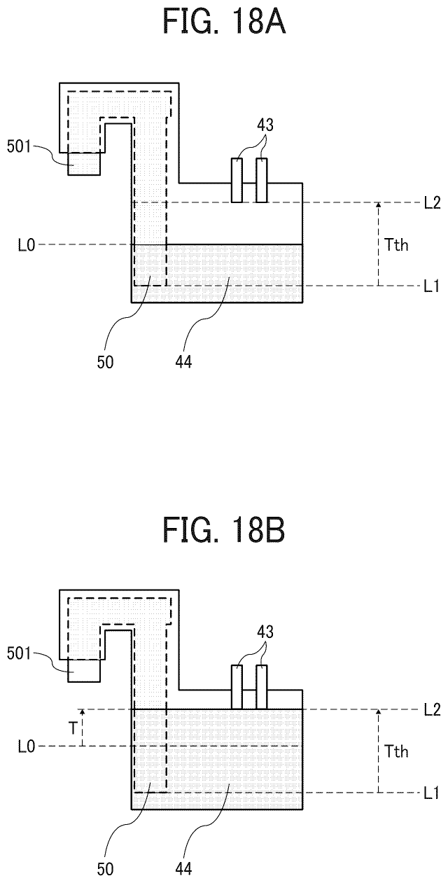

The determination of whether the waiting time is necessary for the transition to the liquid applicable state is described below with reference to FIGS. 17A, 17B, 18A, and 18B. FIG. 17A illustrates a state in which the liquid level (initial liquid level L0) before the liquid supply operation is started is lower than the permeation lower-limit liquid level L1 (i.e., the initial liquid level L0<the permeation lower-limit liquid level L1). FIG. 17B illustrates a state in which the liquid supply operation is started and the liquid level reaches the liquid-detection liquid level L2.

When the liquid is supplied to the liquid application member 501 for the first time or when the amount of liquid in the first liquid storage tank 44 has decreased after being left for a long time, the liquid supply member 50 is not permeated with the liquid. The liquid application member 501 is also dried and may not be in the liquid applicable state.

As illustrated in FIG. 17A, a case is assumed where the liquid supply is started to turn the liquid application member 501 into the liquid applicable state and is also started from the state where the initial liquid level L0 before the liquid supply operation is lower than the permeation lower-limit liquid level L1. In this case, as illustrated in FIG. 17B, even when the liquid level reaches the liquid-detection liquid level L2 (i.e., the liquid supply is completed), there is a possibility that the liquid application member 501 is not permeated with the liquid yet. In such a case, a waiting time occurs in the transition time to the liquid applicable state. In this case, the relation between the supplying time T and the threshold time Tth is “supplying time T>threshold time Tth.”

FIG. 18A illustrates an example in which the liquid level before liquid supply satisfies the relation of “initial liquid level L0≥permeation lower-limit liquid level L1”, the liquid supply member 50 is in the immersion state, and the liquid application member 501 is in the liquid applicable state. FIG. 18B illustrates a state after the liquid supply operation.

For example, when the liquid supply operation is frequently performed or when the liquid is supplied by performing the “additional supply operation” such that the liquid is supplied every time the liquid level falls below the liquid-detection liquid level L2, the liquid supply member 50 is permeated with the liquid, that is, the initial liquid level L0 before the liquid is supplied is higher than the permeation lower-limit liquid level L1 (see FIG. 18A). In this case, even after the liquid supply is started and the liquid supply is completed, the liquid supply member 50 is immersed in the liquid, and the liquid application member 501 is also permeated with the liquid. In such a case, no waiting time occurs during the time of transition to the liquid applicable state, and thus the job can be executed immediately. In this case, the relation between the supplying time T and the threshold time Tth is “supplying time T≤ threshold time Tth.”

A description is given below of a control process of a liquid supply operation related to a transition waiting process to the liquid applicable state.

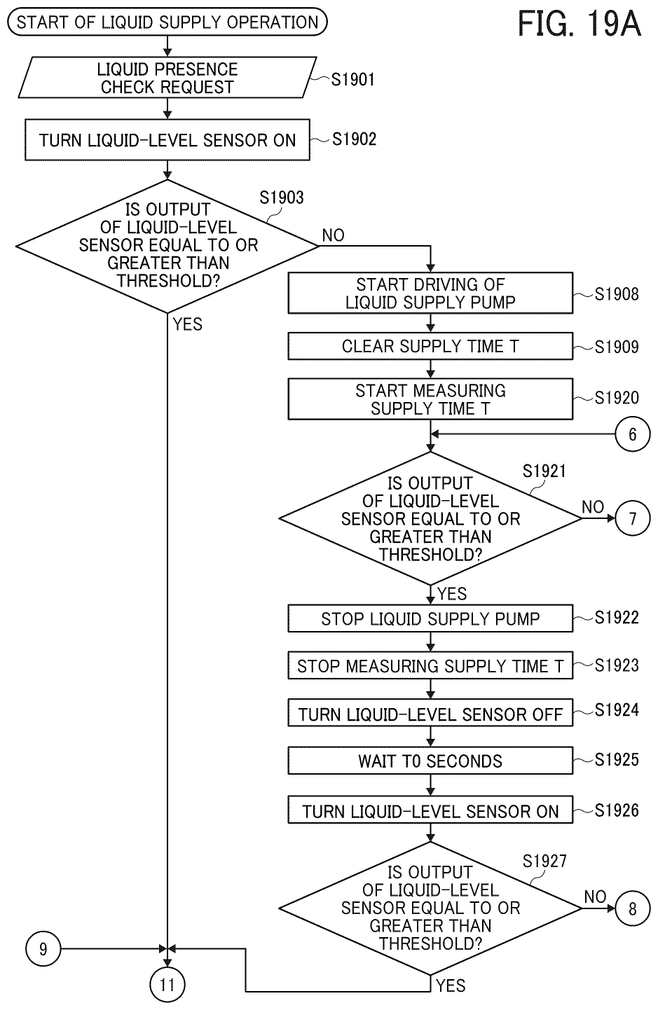

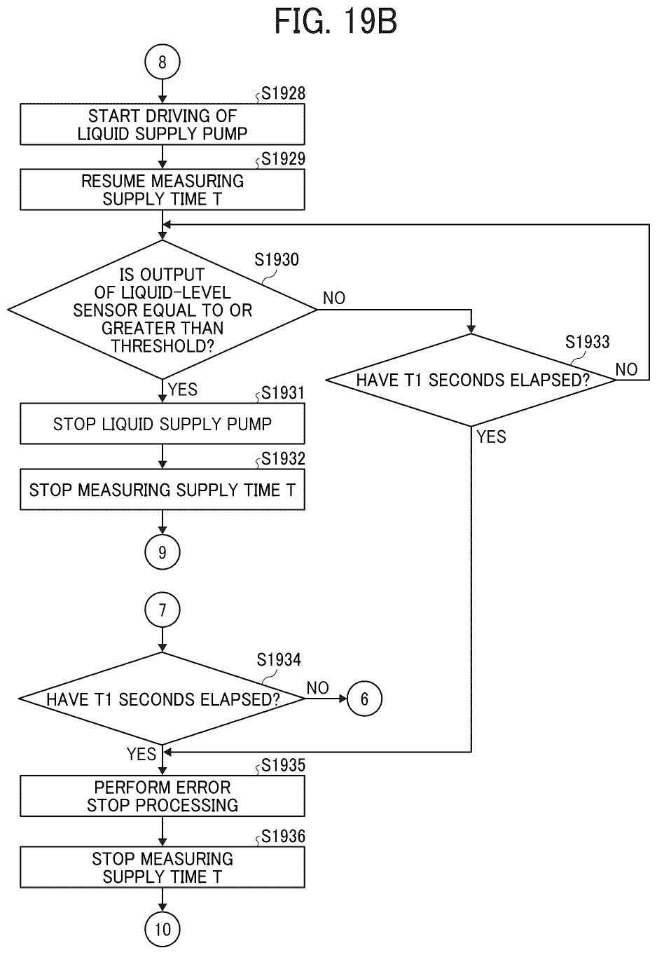

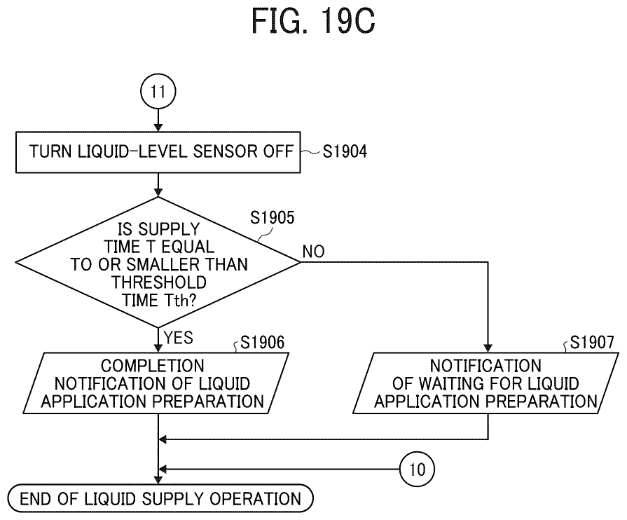

FIGS. 19A, 19B, and 19C are flowcharts illustrating a control process of a liquid supply operation which is an example of the liquid supply operation performed in the controller 100b and which controls whether a waiting time occurs in the transition time in the process of waiting for the transition to the liquid applicable state. The liquid supply operation is started from the liquid level check in the first liquid storage tank 44, for example, when the filling supply control process is started when the post-processing apparatus 3 is activated.

First, when the post-processing apparatus 3 is activated, the filling supply control process is started. When the filling supply control process is started, in step S1901, a liquid presence check request is instructed from the image forming apparatus 2 to the controller 100b. The liquid presence check request may be instructed based on the information input by the user through the operation panel 110 of one or both of the image forming apparatus 2 and the post-processing apparatus 3. In response to receipt of the liquid presence check request instructed from the image forming apparatus 2, in step S1902, the controller 100b applies a voltage to the first liquid-level sensor 43 (i.e., turns on energization).

In step S1903, the controller 100b acquires an output value (voltage) that the first liquid-level sensor 43 outputs, and determines the presence (the stored liquid amount) of liquid in the first liquid storage tank 44. For example, when the output value (voltage) from the first liquid-level sensor 43 on the detection of liquid in the first liquid storage tank 44 is equal to or greater than the liquid detection threshold (e.g., the output voltage V1), the controller 100b determines that the amount of liquid stored in the first liquid storage tank 44 is a sufficient amount (YES in step S1903). In this case, in step S1904, the controller 100b stops the application of voltage to the first liquid-level sensor 43 (i.e., turns off the energization).

Subsequent to step S1904, the controller 100b compares the supplying time T with the threshold time Tth. When “T≤Tth” is satisfied (YES in step S1905), the controller 100b outputs and displays a completion notification of liquid application preparation to and on, for example, the operation panel 110 in step S1906, and ends the liquid supply control process. If “T≤Tth” is not satisfied (NO in step S1905), the controller 100b outputs and displays a notification of waiting for liquid application preparation to and on, for example, the operation panel 110 in step S1907, and ends the liquid supply control process.

Alternatively, when the output value (voltage) from the first liquid-level sensor 43 is less than the liquid detection threshold (e.g., the output voltage V1) in step S1903 (NO in step S1903), in step S1908, the controller 100b operates the liquid supply pump 46 to supply the liquid from the second liquid storage tank 47 to the first liquid storage tank 44.

Subsequently, the controller 100b clears and initializes the supplying time T as a software timer in step S1909, and starts measuring the supplying time T in step S1920.

In step S1921, the controller 100b determines again whether the output value (voltage) from the first liquid-level sensor 43 is equal to or greater than the “liquid detection threshold” (threshold) set in advance. When the output value (voltage) from the first liquid-level sensor 43 is equal to or greater than the liquid detection threshold (e.g., the output voltage V1), the controller 100b determines that a sufficient amount of liquid has been supplied from the second liquid storage tank 47 into the first liquid storage tank 44 by the liquid supply pump 46 (YES in step S1921).

On the other hand, when the output value from the first liquid-level sensor 43 is less than the liquid detection threshold (e.g., the output voltage V1) (NO in step S1921), in step S1934, the controller 100b measures an elapsed time from the start of the operation of the liquid supply pump 46 (step S1908) and determines the elapsed time has reached an abnormality determination time (T1 seconds (sec)). When the elapsed time has not reached the abnormality determination time T1 (NO in step S1934), the controller 100b continues the supply of liquid from the second liquid storage tank 47 to the first liquid storage tank 44 by the liquid supply pump 46 until the output value (voltage) from the first liquid-level sensor 43 becomes equal to or greater than the liquid detection threshold (e.g., the output voltage V1) (YES in step S1921).

On the other hand, when the elapsed time from the start of the operation of the liquid supply pump 46 (step S1908) has reached the abnormality determination time T1 (YES in step S1934), the controller 100b determines that some abnormality (such as a failure of the liquid supply pump 46 and/or the first liquid-level sensor 43) has occurred in a device, and performs error stop processing of stopping the liquid supply pump 46 and/or turning off the energization of the first liquid-level sensor 43 in step S1935. Then, the controller 100b stops the measurement (counting) of the supplying time T in step S1936, and ends the liquid supply control.

In step S1921, when the output value (voltage) from the first liquid-level sensor 43 becomes equal to or greater than the liquid detection threshold (e.g., the output voltage V1) (YES in step S1921), in step S1922, the controller 100b stops the liquid supply pump 46 and stops the supply of liquid from the second liquid storage tank 47 to the first liquid storage tank 44. Then, the controller 100b also temporarily stops the measurement (counting) of the supplying time T in step S1923. Subsequently, in step S1924, the controller 100b stops the application of voltage to the first liquid-level sensor 43 (i.e., turns off the energization).

In step S1925, the controller 100b temporarily stops the liquid supply control using the liquid supply pump 46 until a standby time (first predetermined time TO (seconds)) elapses that is set in advance as a time until the liquid supply member 50 sucks up the liquid in the first liquid storage tank 44 by, e.g., capillary phenomenon and the liquid application member 501 reaches the liquid applicable state (i.e., a state where the liquid is sufficiently stored in the liquid application member 501 and/or the liquid supply member 50).

After the first predetermined time TO has elapsed, the controller 100b turns on the energization of the first liquid-level sensor 43 again (in step S1926), acquires an output value (voltage) that is output when the first liquid-level sensor 43 detects the liquid in the first liquid storage tank 44, and determines the presence (the stored liquid amount) of liquid in the first liquid storage tank 44 (in step S1927). At this stage, the liquid level (stored liquid amount) of liquid in the first liquid storage tank 44 decreases due to the sucking-up of the liquid supply member 50. However, when the output value (voltage) from the first liquid-level sensor 43 is equal to or greater than the liquid detection threshold (e.g., the output voltage V1) (YES in step S1927), in step S1904, the controller 100b stops the application of the voltage to the first liquid-level sensor 43 (i.e., turns off the energization).

Subsequent to step S1904, the controller 100b compares the supplying time T with the threshold time Tth. When “T≤Tth” is satisfied (YES in step S1905), the controller 100b outputs and displays a completion notification of liquid application preparation to and on, for example, the operation panel 110 in step S1906, and ends the liquid supply control process. If “T≤Tth” is not satisfied (NO in step S1905), the controller 100b outputs and displays a notification of waiting for liquid application preparation to and on, for example, the operation panel 110 in step S1907, and ends the liquid supply control process.

Alternatively, when the output value (voltage) from the first liquid-level sensor 43 is less than the liquid detection threshold (e.g., the output voltage V1) in step S1927 (NO in step S1927), in step S1929, the controller 100b operates the liquid supply pump 46 to supply the liquid from the second liquid storage tank 47 to the first liquid storage tank 44.

Subsequently, the controller 100b restarts the measurement of the supplying time T as the software timer in step S1929.

Subsequently, the controller 100b acquires an output value (voltage) that is output when the first liquid-level sensor 43 detects liquid in the first liquid storage tank 44, and determines the presence (the stored liquid amount) of liquid in the first liquid storage tank 44 in step S1930. When the output value (voltage) from the first liquid-level sensor 43 is equal to or greater than the liquid detection threshold (e.g., the output voltage V1) (YES in step S1930), the controller 100b determines that a sufficient amount of liquid has been supplied into the first liquid storage tank 44. In this case, the controller 100b stops the liquid supply pump 46 to stop supplying the liquid from the second liquid storage tank 47 to the first liquid storage tank 44 in step S1931, and also stops measuring the supplying time T in step S1932.

Subsequent to step S1904, the controller 100b compares the supplying time T with the threshold time Tth. When “T≤Tth” is satisfied (YES in step S1905), the controller 100b outputs and displays a completion notification of liquid application preparation to and on, for example, the operation panel 110 in step S1906, and ends the liquid supply control process. If “T≤Tth” is not satisfied (NO in step S1905), the controller 100b outputs and displays a notification of waiting for liquid application preparation to and on, for example, the operation panel 110 in step S1907, and ends the liquid supply control process.

On the other hand, when the output value (voltage) from the first liquid-level sensor 43 is less than the liquid detection threshold (e.g., the output voltage V1) (NO in step S1930), in step S1933, the controller 100b determines whether the elapsed time from the start (step S1929) of the operation of the liquid supply pump 46 has reached the abnormality determination time (T1 seconds). When the elapsed time has not reached the abnormality determination time T1 (NO in step S1933), the controller 100b continues the supply of liquid from the second liquid storage tank 47 to the first liquid storage tank 44 by the liquid supply pump 46 until the output value (voltage) from the first liquid-level sensor 43 becomes equal to or greater than the liquid detection threshold (e.g., the output voltage V1) (YES in step S1930).

On the other hand, when the elapsed time has reached the abnormality determination time T1 (YES in step S1933), the controller 100b determines that some kind of abnormality has occurred in the apparatus, and performs error stop processing of stopping the liquid supply pump 46 and/or turning off the energization of the first liquid-level sensor 43 in step S1935. Then, the controller 100b stops the measurement (counting) of the supplying time T in step S1936, and ends the liquid supply control.

The relationship between the liquid supply determination control described above and the contents described with reference to FIGS. 17A, 17B, 18A, and 18B is described below. First, when the controller 100b checks the presence of the liquid in the first liquid storage tank 44 as the stage preceding to the state illustrated in FIG. 17A and determines that the first liquid storage tank 44 has “no liquid” (NO in step S1903), the controller 100 drives the liquid supply pump 46 to replenish the liquid to the first liquid storage tank 44. Then, when the liquid in the first liquid storage tank 44 becomes the state illustrated in FIG. 13B, the controller 100b stops the liquid supply pump 46 (YES in step S1921).

Subsequently, as illustrated in FIG. 13C, when the standby time (TO) set in advance as a time for the liquid supply member 50 to suck up the liquid elapses, the liquid level lowers. Thus, the output value (voltage) from the first liquid-level sensor 43 becomes less than the liquid-level detection threshold (e.g., the threshold V0) (NO in step S1927). Then, the controller 100b operates the liquid supply pump 46 to supply the liquid from the second liquid storage tank 47 to the first liquid storage tank 44, so that the liquid in the first liquid storage tank 44 become the state illustrated in FIG. 13C (YES in step S1927).

When the liquid supply is started from the state of FIG. 17A, the liquid applicable state is notified after the supplying is successful in step S1906. When the ink supply is started from the state illustrated in FIG. 18A, in step S1907, the controller 100b issues the notification of waiting for liquid application preparation after the liquid supply is successful.

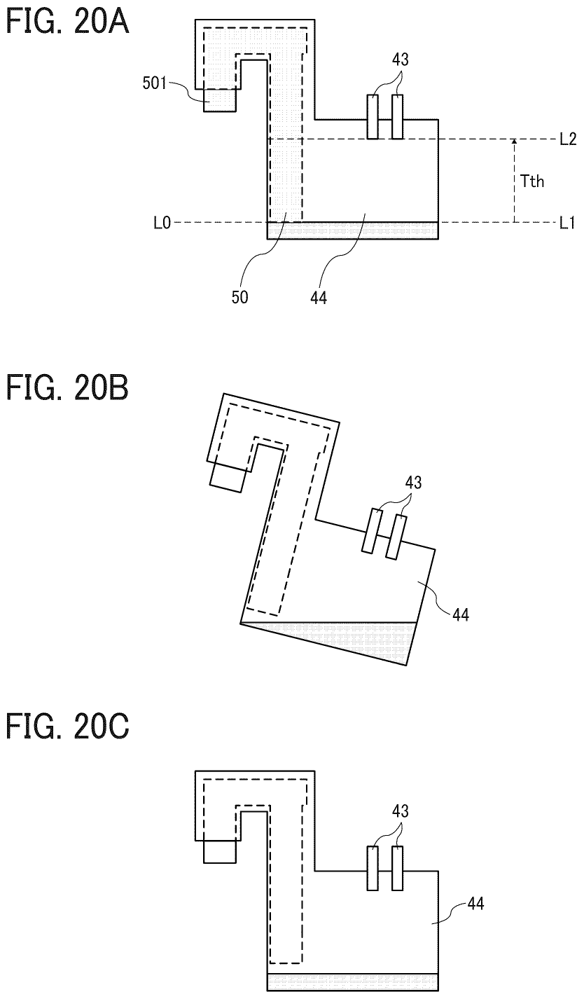

A description is given below of adjustment items in the threshold time Tth. FIG. 20A illustrates a state in which the initial liquid level L0 is close to the permeation lower-limit liquid level L1. FIGS. 20B and 20C illustrate examples in which the amount of liquid stored in the first liquid storage tank 44 is the same, but the first liquid storage tank 44 is inclined or has a variability as a component.

As the lower surface of the liquid supply member 50 approaches the boundary with the permeation lower-limit liquid level L1 (FIG. 20A), the threshold time Tth (the permeation lower-limit liquid level L1) is more likely to be affected by errors such as an inclination due to the installation environment (FIG. 20B) and a variability in the shorter length of the liquid supply member 50 (FIG. 20C).

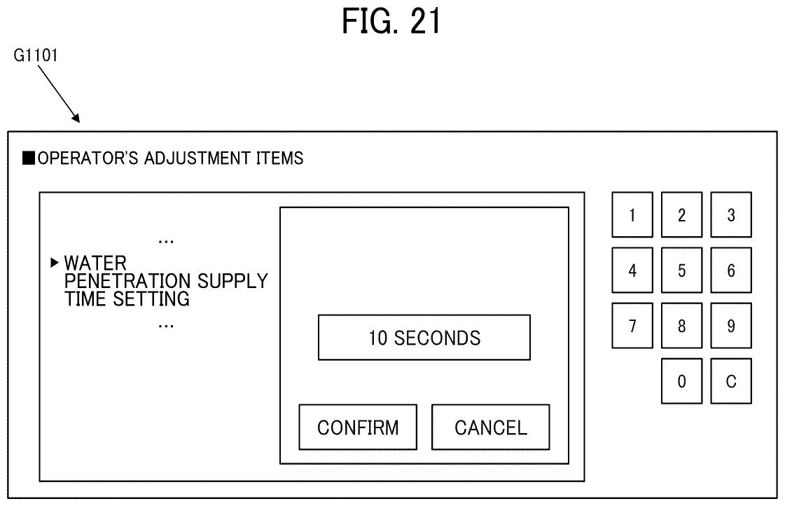

For this reason, an adjustment screen G1101 as illustrated in FIG. 21 is displayed on the operation panel 110 as an input device, and the threshold time Tth for appropriately determining the liquid applicable state can be adjusted by any input value of the user.

For example, in a configuration in which liquid is applied to media stacked for binding as a sheet bundle, a sub tank that temporarily stores liquid among liquid storage tanks included in a mechanism (liquid applying unit) that applies the liquid may be in a liquid absent state. In such a case, it may be difficult to estimate the time until liquid application becomes executable after the execution of liquid replenishment to the sub tank. In particular, it may not be possible to estimate a transition time until the liquid fully permeates a liquid application member included in the liquid applying unit so that the liquid can be applied to a medium, that is, the transition time to a liquid applicable state, and thus the downtime in the liquid-application crimp binding may occur.

As described above, in the post-processing apparatus 3 according to the present embodiment described above, the liquid supply control is provided with the control of measuring the amount of liquid in the first liquid storage tank 44. When the amount of liquid is equal to or greater than a predetermined amount, the post-processing apparatus 3 can immediately transition to the liquid applicable state. In addition, when the amount of liquid is less than the predetermined amount, the post-processing apparatus 3 transitions to the liquid applicable state after waiting for a predetermined time. Executing such liquid supply control has an advantageous effect of allowing the time for transition to the liquid applicable state to be changed in accordance with the amount of liquid in the first liquid storage tank 44 which is an example of a sub tank.

A description is given below of a post-processing apparatus 3A according to a second embodiment of the present disclosure.

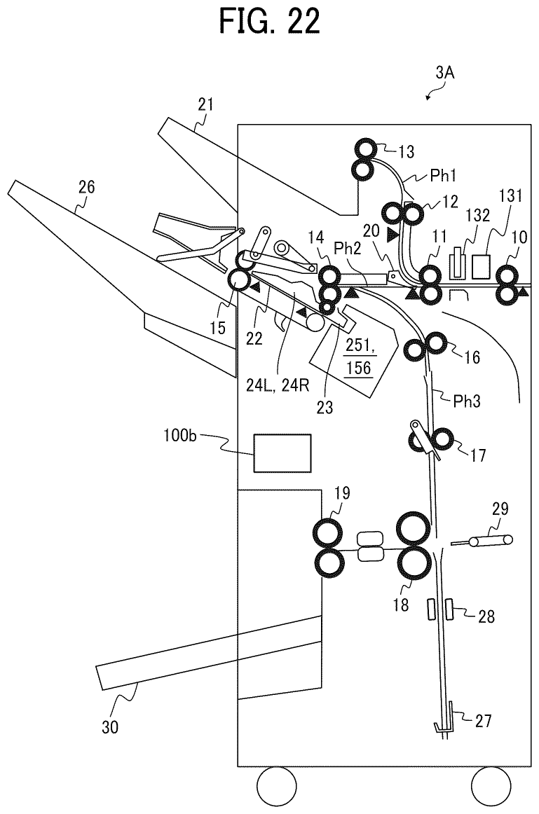

The post-processing apparatus 3A according to the second embodiment is described below with reference to FIGS. 22 to 30. In the following description, the same or similar components as those of the post-processing apparatus 3 according to the first embodiment are denoted by the identical or similar reference signs, and redundant descriptions thereof may be omitted.

The post-processing apparatus 3A according to the second embodiment includes an edge binder 251. The edge binder 251 is different from the edge binder 25 of the post-processing apparatus 3 according to the first embodiment, in which the liquid applier 31 and the crimper 32 are arranged side by side, in that the edge binder 251 includes a crimper 32′ and a liquid applier 131 is disposed at an upstream position in a direction in which a sheet P is conveyed. Such a configuration allows a given number of sheets P to be stacked after the liquid application process and conveyed to the crimper 32′ of the edge binder 251 disposed at a downstream position of the conveyance passage in the direction in which the sheet P is conveyed. Accordingly, the productivity of the binding process performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to both the opposite conveyance direction and the thickness direction of the sheet P is defined as the “main scanning direction” or the “width direction of the sheet P.” The liquid application position on a sheet P or a sheet bundle Pb onto which liquid application is performed by the liquid applier 131 corresponds to the binding position on the sheet bundle Pb to be crimped by the crimper 32′. For this reason, in the following description, the liquid application position and the binding position are described with the same reference sign (B1).

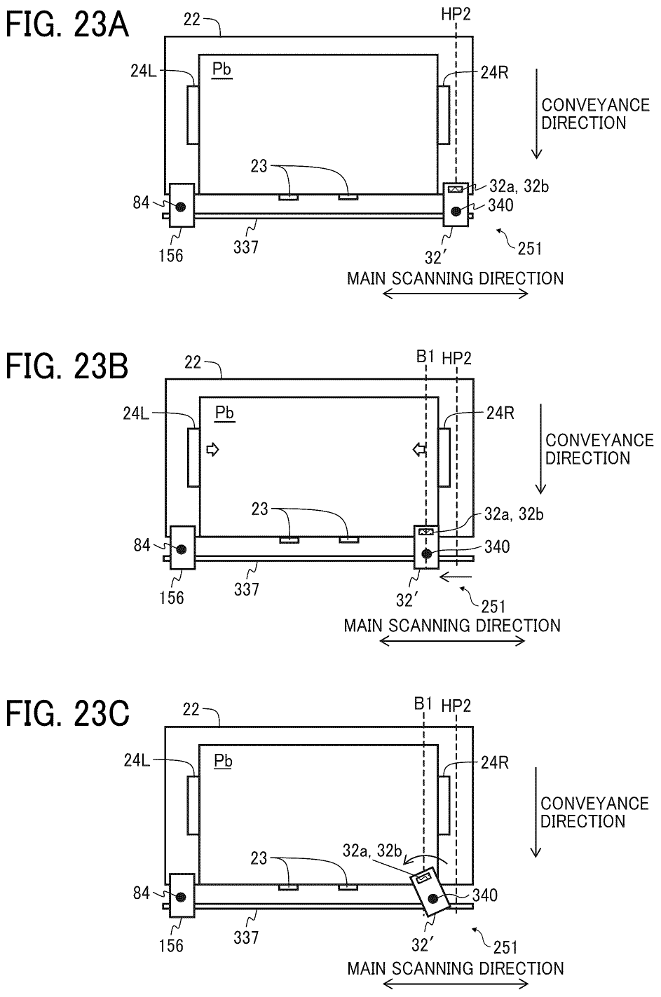

FIG. 22 is a diagram illustrating an internal configuration of the post-processing apparatus 3A according to the second embodiment of the present disclosure. As illustrated in FIGS. 23A, 23B, and 23C, the edge binder 251 includes only the crimper 32′. As illustrated in FIGS. 23A, 23B, and 23C, the crimper 32′ and the staple binder 156 are disposed downstream from the internal tray 22 in the conveyance direction. In addition, the crimper 32′ and the staple binder 156 are located to face a downstream end, in the conveyance direction, of the sheet bundle Pb placed on the internal tray 22 and is movable in the main scanning direction.

Further, the crimper 32′ and the staple binder 156 are respectively rotatable in the forward and reverse directions about a crimper shaft 340 and a stapler shaft 84 both extending in the thickness direction of the sheet bundle Pb placed on the internal tray 22. In other words, the crimper 32′ and the staple binder 156 bind, at a desired angle, a desired position in the main scanning direction on the sheet bundle Pb placed on the internal tray 22 in, for example, corner oblique binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb. In the following description, such a binding way may be referred to as “crimping.” In other words, the crimper 32′ crimps and binds the sheet bundle Pb or performs the crimping on the sheet bundle Pb. On the other hand, the staple binder 156 passes the staple through a binding position on the sheet bundle Pb placed on the internal tray 22, thus allowing the sheet bundle Pb to be stapled.

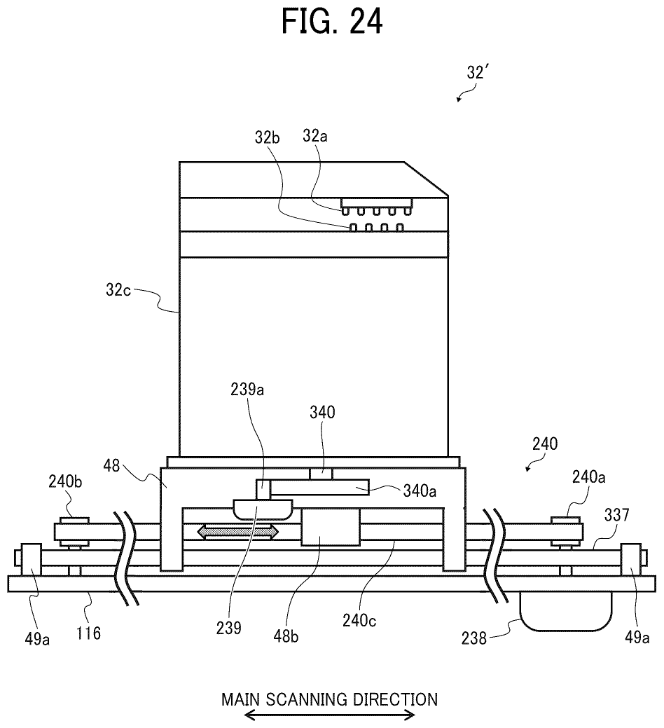

Each of FIGS. 23A, 23B, and 23C is a schematic view of the internal tray 22 in the thickness direction of the sheet bundle Pb. FIG. 24 is a schematic view of a downstream side of the crimper 32′ in the conveyance direction. As illustrated in FIGS. 23A, 23B, and 23C, the crimper 32′ and the staple binder 156 are disposed downstream from the internal tray 22 in the conveyance direction. The crimper 32′ is movable in the main scanning direction along the surface of the sheet bundle Pb placed on the internal tray 22. Further, the crimper 32′ is rotatable in the forward and reverse directions about the crimper shaft 340 extending in the thickness direction of the sheet bundle Pb placed on the internal tray 22.

Similarly, the staple binder 156 is configured to be movable in the main scanning direction of the sheet bundle Pb. Further, the staple binder 156 is rotatable in the forward and reverse directions about a stapler shaft 84 extending in thickness direction of the sheet bundle Pb. The other components of the staple binder 156 are similar to, even if not the same as, those of the staple binder 155 (see FIG. 6) of the post-processing apparatus 3 according to the first embodiment. For this reason, a detailed description thereof is omitted.

As illustrated in FIG. 24, the crimper 32′ includes a guide rail 337 extending in the main scanning direction at a position downstream from the internal tray 22 in the conveyance direction. The crimper 32′ includes a crimper movement motor 238 as a driving source. A base 48 supporting a crimping frame 32c has a fastening portion 48b for a timing belt 240c at the bottom of the base 48. Accordingly, the driving force of the crimper movement motor 238 is transmitted to the base 48 by a drive transmission assembly 240 that includes pullies 240a and 240b, the timing belt 240c, and the fastening portion 48b. Thus, the crimper 32′ is moved in the main scanning direction along the surface of the sheet bundle Pb placed on the internal tray 22 (in other words, the guide rail 337). The crimper shaft 340 including a drive transmission gear 340a is fixed to a bottom face of the crimping frame 32c that holds the components of the crimper 32′.

The crimper shaft 340 and the drive transmission gear 340a are held by the base 48 on which the crimping frame 32c is disposed, so as to be rotatable in the forward and reverse directions. The drive transmission gear 340a meshes with an output gear 239a of a crimper pivot motor 239. When the driving force of the crimper pivot motor 239 is transmitted to the crimper shaft 340 via the output gear 239a and the drive transmission gear 340a, the crimper 32′ rotates in the forward and reverse directions on the base 48 about the crimper shaft 340 extending in the thickness direction of the sheet P placed on the internal tray 22. The guide rail 337, the crimper movement motor 238, the crimper pivot motor 239, the crimper shaft 340, and the drive transmission assembly 240 constitute at least part of a driving assembly of the crimper 32′ according to the present embodiment.

The crimper 32′ moves between the standby position HP2 illustrated in FIG. 23A and a position where the crimper 32′ faces the first binding position B1 illustrated in FIGS. 23B and 23C. The standby position HP2 is a position away in the main scanning direction from the sheet bundle Pb placed on the internal tray 22. The first binding position B1 is a position on the sheet bundle Pb placed on the internal tray 22. However, the specific position of the first binding position B1 is not limited to the position illustrated in FIGS. 23B and 23C. The first binding position B1 may be one or more positions along the main scanning direction at the downstream end, in the conveyance direction, of the sheet P.

The posture of the crimper 32′ changes between a parallel binding posture illustrated in FIG. 23B and an oblique binding posture illustrated in FIG. 23C. In other words, the crimper 32′ is rotatable in the forward and reverse directions about the crimper shaft 340. The parallel binding posture is a posture of the crimper 32′ in which the longitudinal direction of the upper crimping teeth 32a and the lower crimping teeth 32b (i.e., a rectangular crimp binding trace) is along the main scanning direction. The oblique binding posture is a posture of the crimper 32′ in which the longitudinal direction of the upper crimping teeth 32a and the lower crimping teeth 32b (i.e., the rectangular crimp binding trace) is inclined with respect to the main scanning direction.

The rotational angle, which is an angle of the upper crimping teeth 32a and the lower crimping teeth 32b with respect to the main scanning direction, in the oblique binding posture is not limited to the angle illustrated in FIG. 23C. The rotational angle in the oblique binding posture may be any angle provided that the upper crimping teeth 32a and the lower crimping teeth 32b face the sheet bundle Pb placed on the internal tray 22.

The post-processing apparatus 3A includes the liquid applier 131 and a hole punch 132, which is an example of a processor. The liquid applier 131 and the hole punch 132 are disposed upstream from the internal tray 22 in the opposite conveyance direction. In addition, the liquid applier 131 and the hole punch 132 are disposed at different positions in the opposite conveyance direction to simultaneously face one sheet P that is conveyed by the conveyance roller pairs 10 to 19.

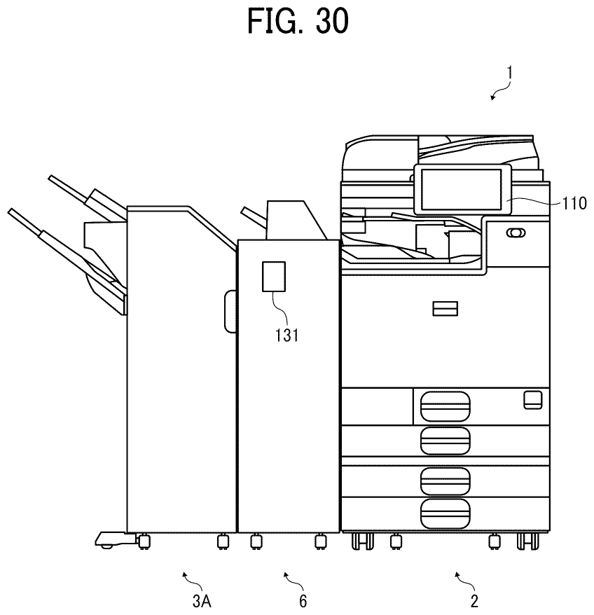

The liquid applier 131 and the hole punch 132 according to the present embodiment are disposed between the conveyance roller pairs 10 and 11. However, the arrangement of the liquid applier 131 is not limited to the example of FIG. 22. For example, in a case where an inserter 6 is disposed between the image forming apparatus 2 and the post-processing apparatus 3A as illustrated in FIG. 30, the liquid applier 131 may be disposed inside the inserter 6 located upstream from the post-processing apparatus 3A in a direction in which the sheet P is conveyed from the image forming apparatus 2 to the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

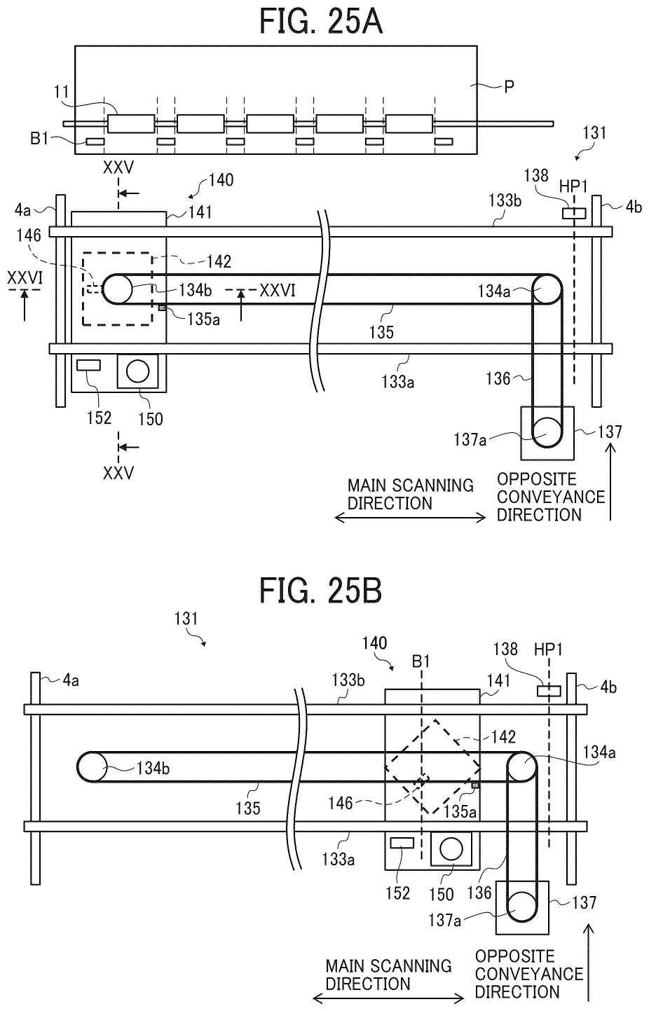

As illustrated in FIG. 25A, the conveyance roller pair 11 is located so as not to overlap, in the main scanning direction, the first liquid application position B1 on the sheet P to which the liquid has been applied by a liquid application head 146 of the liquid applier 131. This arrangement is to prevent the amount of liquid at the first liquid application position B1 from decreasing due to the multiple roller pairs pressing the first liquid application position B1 when the conveyance roller pair 11 conveys the sheet P. As a result, when the sheet P reaches the crimper 32′ disposed downstream from the liquid applier 131 in the opposite conveyance direction, the amount of liquid at the first liquid application position B1 is sufficient to maintain the binding strength. Accordingly, the binding strength of the sheet bundle Pb is prevented from decreasing due to a decrease in the amount of liquid at the first liquid application position B1 (corresponding to the first binding position B1) while the sheet P is conveyed.

In addition, the multiple roller pairs of the conveyance roller pair 11 that is located so as not to overlap the first liquid application position B1 on the sheet P in the main scanning direction prevents the conveying performance of the sheet P from being worse due to the adhesion of liquid to the multiple roller pairs and further prevents a conveyance jam caused by the worsened conveying performance of the sheet P.

Although only the conveyance roller pair 11 has been described above, the multiple roller pairs of the conveyance roller pairs 14 and 15 are preferably located so as not to overlap the first liquid application position B1 on the sheet P in the main scanning direction, like the multiple roller pairs of the conveyance roller pair 11.

The liquid applier 131 applies liquid to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

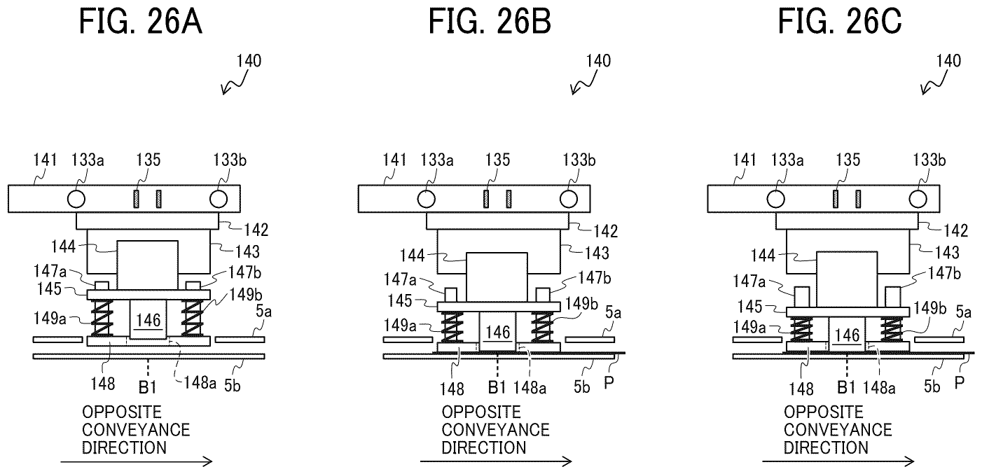

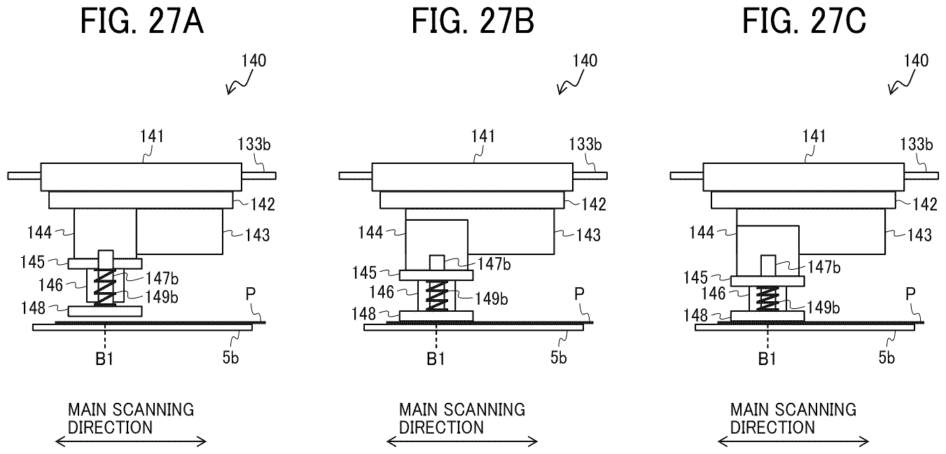

FIGS. 25A and 25B are views of the liquid applier 131 in the thickness direction of the sheet P, according to the second embodiment of the present disclosure. FIGS. 26A, 26B, and 26C are cross-sectional views of a liquid application unit 140 of the liquid applier 131 taken through XXV-XXV of FIG. 25A. FIGS. 27A, 27B, and 27C are cross-sectional views of the liquid application unit 140 of the liquid applier 131 taken through XXVI-XXVI of FIG. 25A. As illustrated in FIGS. 25A to 27C, the liquid applier 131 includes a pair of guide shafts 133a and 133b, a pair of pulleys 134a and 134b, endless annular belts 135 and 136, a liquid-application-unit movement motor 137, a standby position sensor 138, and a liquid application unit 140.

The pair of guide shafts 133a and 133b each extend in the main scanning direction at positions spaced apart from each other in the opposite conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the guide shafts 133a and 133b in the opposite conveyance direction. On the other hand, the pulleys 134a and 134b are apart from each other in the main scanning direction. The pulleys 134a and 134b are supported by a frame of the post-processing apparatus 3A so as to be rotatable in the forward and reverse directions about the respective shafts extending in the thickness direction of the sheet P.

The endless annular belt 135 is looped around the pair of pulleys 134a and 134b. The endless annular belt 135 is coupled to the liquid application unit 140 by a connection 135a. The endless annular belt 136 is looped around the pulley 134a and a driving pulley 137a that is fixed to an output shaft of the liquid-application-unit movement motor 137. The liquid-application-unit movement motor 137 generates a driving force to move the liquid application unit 140 in the main scanning direction.

As the liquid-application-unit movement motor 137 rotates, the endless annular belt 136 circulates around the pulley 134a and the driving pulley 137a to rotate the pulley 134a. As the pulley 134a rotates, the endless annular belt 135 circulates between the pair of pulleys 134a and 134b. Thus, the liquid application unit 140 moves in the main scanning direction along the pair of guide shafts 133a and 133b. The liquid application unit 140 reciprocates in the main scanning direction in response to switching of the rotation direction of the liquid-application-unit movement motor 137.

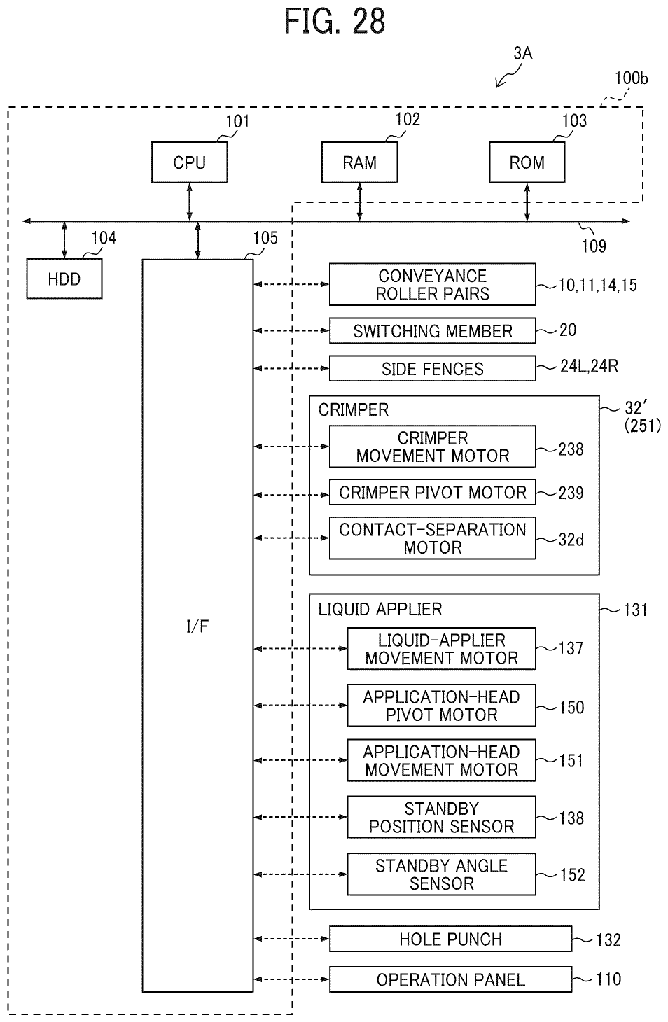

The standby position sensor 138 detects that the liquid application unit 140 has reached a standby position HP1 (see FIGS. 25A and 25B) in the main scanning direction. The standby position sensor 138 then outputs a standby position signal indicating the detection result to the controller 100b, which will be described below with reference to FIG. 28. The standby position sensor 138 is, for example, an optical sensor including a light emitter and a light receiver. At the standby position HP1, the liquid application unit 140 blocks the optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 26A, 26B, and 26C, the conveyance passage inside the post-processing apparatus 3A is defined by an upper guide plate 5a and a lower guide plate 5b, which are apart from each other in the thickness direction of the sheet P. The liquid application unit 140 is located to face an opening of the upper guide plate 5a. In other words, the liquid application unit 140 is disposed to face the conveyance passage (a position at which the liquid application unit 140 can face the sheet P) through the opening of the upper guide plate 5a.

As illustrated in FIGS. 25A to 27C, the liquid application unit 140 includes a base 141, a rotary bracket 142, a liquid storage tank 143, a liquid-application-head mover 144, a holder 145, the liquid application head 146, columns 147a and 147b, a pressure plate 148, coil springs 149a and 149b, the application-head pivot motor 150, the application-head movement motor 151 (see FIG. 28), and a standby angle sensor 152 (see FIG. 28).

The base 141 is supported by the pair of guide shafts 133a and 133b so as to be slidable in the main scanning direction. The base 141 is coupled to the endless annular belt 135 by the connection 135a. The base 141 supports the components 142 to 152 of the liquid application unit 140.

The rotary bracket 142 is attached to the lower face of the base 141 so as to be rotatable in the forward and reverse directions about an axis extending in the thickness direction of the sheet P. The rotary bracket 142 is rotated with respect to the base 141 by a driving force transmitted from the application-head pivot motor 150. The rotary bracket 142 retains the liquid storage tank 143, the liquid-application-head mover 144, the holder 145, the liquid application head 146, the columns 147a and 147b, the pressure plate 148, and the coil springs 149a and 149b.

The standby angle sensor 152, which is also illustrated in FIG. 28, detects that the rotary bracket 142 has reached a standby angle. The standby angle sensor 152 then outputs a standby angle signal indicating the detection result to the controller 100b. The standby angle is, for example, an angle at the time of performing parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. However, the specific configuration of the standby angle sensor 152 is not limited to the above-described example.

FIG. 25A illustrates the rotary bracket 142 in a position for the parallel binding that is performed by the crimper 32′ disposed downstream from the liquid applier 131 in a direction in which the sheet P is conveyed. FIG. 25B illustrates the rotary bracket 142 in a position for the oblique binding (i.e., corner binding) that is performed by the crimper 32′ disposed downstream from the liquid applier 131 in the direction in which the sheet P is conveyed.

The liquid storage tank 143 stores liquid to be applied to the sheet P. The liquid-application-head mover 144 is attached to the liquid storage tank 143 so as to be movable (e.g., up and down) in the thickness direction of the sheet P. The liquid-application-head mover 144 moves with respect to the liquid storage tank 143 by a driving force transmitted from the application-head movement motor 151. The holder 145 is attached to a lower end of the liquid-application-head mover 144. The liquid application head 146 projects from the holder 145 toward the conveyance passage (downward in the present embodiment). The liquid that is stored in the liquid storage tank 143 is supplied to the liquid application head 146. The liquid application head 146 is made of a material having a high liquid absorption (e.g., sponge or fiber).

The columns 147a and 147b project downward from the holder 145 around the liquid application head 146. The columns 147a and 147b are movable with respect to the holder 145 relatively in the thickness direction. The columns 147a and 147b hold the pressure plate 148 at lower ends thereof. The pressure plate 148 has a through hole 148a at a position to face the liquid application head 146. The coil springs 149a and 149b are inserted to the outsides of the columns 147a and 147b between the holder 145 and the pressure plate 148. The coil springs 149a and 149b bias the columns 147a and 147b and the pressure plate 148 in a direction away from the holder 145.

As illustrated in FIGS. 26A and 27A, before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the first liquid application position B1 on the sheet P faces the opening, the application-head movement motor 151 is rotated in a first direction. As a result, the liquid-application-head mover 144, the holder 145, the liquid application head 146, the columns 147a and 147b, the pressure plate 148, and the coil springs 149a and 149b are moved down together to allow the pressure plate 148 to contact the sheet P. The first liquid application position B1 corresponds to the first binding position B1 to be crimped and bound by the edge binder 251, specifically, the crimper 32′.

As the application-head movement motor 151 keeps rotating in the first direction even after the pressure plate 148 contacts the sheet P, the coil springs 149a and 149b are compressed to further move down the liquid-application-head mover 144, the holder 145, the liquid application head 146, and the columns 147a and 147b. As a result, as illustrated in FIGS. 26B and 27B, a lower face of the liquid application head 146 contacts the sheet P through the through hole 148a. As a result, the liquid contained in the liquid application head 146 is applied to the sheet P.

Further rotation of the application-head movement motor 151 in the first direction further strongly presses the liquid application head 146 against the sheet P as illustrated in FIGS. 26C and 27C. Accordingly, the amount of liquid applied to the sheet P increases. In short, the liquid applier 131 changes the pressing force of the liquid application head 146 against the sheet P to adjust the amount of liquid applied to the sheet P.

On the other hand, the rotation of the application-head movement motor 151 in the second direction opposite to the first direction moves up the liquid-application-head mover 144, the holder 145, the liquid application head 146, the columns 147a and 147b, the pressure plate 148, and the coil springs 149a and 149b together. As a result, as illustrated in FIGS. 26A and 27A, the liquid application head 146 and the pressure plate 148 are separated from the sheet P. In other words, the liquid applier 131 includes the liquid application head 146 that can be separated from the sheet P.

FIG. 28 is a block diagram illustrating a hardware configuration of the post-processing apparatus 3A to control the operation of the post-processing apparatus 3A according to the second embodiment of the present disclosure. As illustrated in FIG. 28, the post-processing apparatus 3A has a configuration in which a central processing unit (CPU) 101, a random-access memory (RAM) 102, a read-only memory (ROM) 103, a hard disk drive (HDD) 104, and an interface (I/F) 105 are connected via a common bus 109.

The CPU 101 is an arithmetic device and controls the overall operation of the post-processing apparatus 3A. The RAM 102 is a volatile storage medium that allows high speed reading and writing of data, and is used as a working area when the CPU 101 processes information. The ROM 103 is a read-only non-volatile storage medium, and stores programs such as firmware. The HDD 104 is a non-volatile storage medium that allows data to be read and written and has a relatively large storage capacity. The HDD 104 stores, for example, an operating system (OS), various control programs, and application programs.

The post-processing apparatus 3 processes, by an arithmetic function of the CPU 101, e.g., a control program stored in the ROM 103 and an information processing program (or application program) loaded into the RAM 102 from a storage medium such as the HDD 104. With such processing, a software controller including various functional modules of the post-processing apparatus 3A is configured. The software controller thus configured is combined with hardware resources of the post-processing apparatus 3A mounted in the post-processing apparatus 3A to configure functional blocks that implement functions of the post-processing apparatus 3A. In other words, the CPU 101, the RAM 102, the ROM 103, the HDD 104, and the I/F 105 constitute at least part of the controller 100b (control device) that controls the operation of the post-processing apparatus 3A.

The I/F 105 is an interface that connects the conveyance roller pairs 10, 11, 14, and 15, the switching member 20, the side fences 24L and 24R, the crimper movement motor 238, the crimper pivot motor 239, a contact-separation motor 32d, a liquid-application-unit movement motor 137, an application-head pivot motor 150, an application-head movement motor 151, a standby position sensor 138, a standby angle sensor 152, a hole punch 132, and an operation panel 110 to the common bus 109.

The controller 100b controls, via the I/F 105, the operations of the conveyance roller pairs 10, 11, 14, and 15, the switching member 20, the side fences 24L and 24R, the crimper movement motor 238, the crimper pivot motor 239, the contact-separation motor 32d, the liquid-application-unit movement motor 137, the application-head pivot motor 150, the application-head movement motor 151, and the hole punch 132. The controller 100b acquires detection results from the standby position sensor 138 and the standby angle sensor 152 through the I/F 105.

Although FIG. 28 mainly illustrates the components of the edge binder 251 (the crimper 32′) that executes the edge binding and the liquid applier 131, the components of the saddle binder 28 that executes saddle binding are controlled by the controller 100b in a similar manner.

As illustrated in FIG. 30, the image forming apparatus 2 includes the operation panel 110. The operation panel 110 includes an operation section that receives instructions input by an operator and a display (which is an example of a notifier) that notifies the operator of information. The operation section includes, for example, hard keys and a touch screen overlaid on the display. The operation panel 110 acquires information from the user through the operation section and provides information to the user through the display. The post-processing apparatus 3A may include an operation panel 110 similar to the above-described operation panel 110.

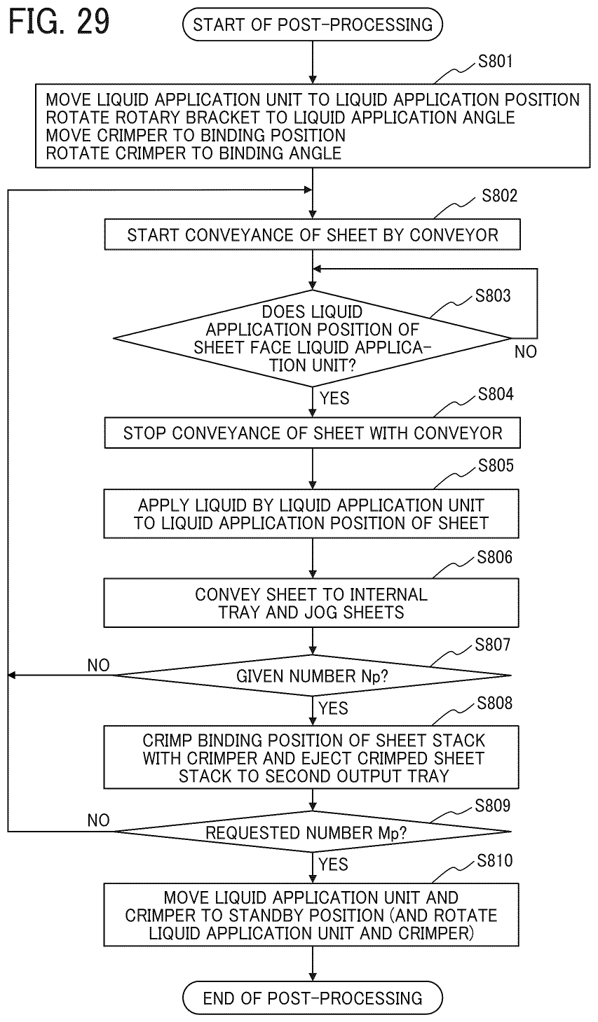

FIG. 29 is a flowchart of post-processing performed by the post-processing apparatus 3A according to the second embodiment. Specifically, FIG. 29 is a flowchart of a process to execute the one-point binding illustrated in FIGS. 23A, 23B, and 23C.

For example, the controller 100b executes the post-processing illustrated in FIG. 29 in response to acquisition of an instruction (denoted below as “post-processing command”) of executing the post-processing from the image forming apparatus 2. The post-processing command includes, for example, the number of sheets P of the sheet bundle Pb (referred to as “given number of sheets Np”), the number of sheet bundles Pb to be subjected to binding processing, the first binding position B1 (corresponding to the first liquid application position B1), the angle of the first binding position B1 (corresponding to the angle of the first liquid application position B1), the type of binding process (parallel binding process or oblique binding process), and a process that is executed in parallel with the liquid application process (i.e., punching a hole in the present embodiment). In the following description, the number of sheets P of the sheet bundle Pb may be referred to as a “given number of sheets Np,” and the number of sheet bundles Pb to be subjected to binding processing may be referred to as “requested number of copies Mp.” At the start of the post-processing, the liquid application unit 140 is at the standby position HP1 (see FIGS. 25A and 25B), and the rotary bracket 142 is held at the standby angle (corresponding to “parallel binding posture”).

First, the controller 100b drives the liquid-application-unit movement motor 137 to move the liquid application unit 140 (corresponding to a liquid applier) in the main scanning direction such that a liquid application head 146 moves from the standby position HP1 to a position where the liquid application head 146 can face the first liquid application position B1 (see FIG. 25B) corresponding to the first binding position B1 illustrated in FIGS. 23B and 23C. If the type of the binding process instructed by the post-processing command is “oblique binding process,” in step S801, the controller 100b drives the application-head pivot motor 150 to rotate the rotary bracket 142. Thus, the liquid application head 146 is rotated from the standby angle to the liquid application angle corresponding to the “oblique binding posture.” It is ascertained, based on a pulse signal output from a rotary encoder of the liquid-application-unit movement motor 137, that the liquid application head 146 has reached the position where the liquid application head 146 can face the first liquid application position B1. Similarly, it is ascertained, based on a pulse signal output from a rotary encoder of the application-head pivot motor 150, that the liquid application head 146 has reached the liquid application angle. If the type of the binding process instructed by the post-processing command is “parallel binding process”, the controller 100b omits the above-described operation of rotating the rotary bracket 142. In other words, the liquid application unit 140 moves in the main scanning direction while holding the rotary bracket 142 at the standby angle.

In step S801, the controller 100b also drives the crimper movement motor 238 to move the crimper 32′ from the standby position HP2 to the position where the crimper 32′ can face the first binding position B1 as illustrated in FIGS. 23A and 23B. Alternatively, if the type of the binding process instructed by the post-processing command is “oblique binding process,” in step S801, the controller 100b drives the crimper pivot motor 239 to rotate the crimper 32′ from the standby angle to the crimping angle corresponding to the “oblique binding posture.” It is ascertained, based on a pulse signal output from a rotary encoder of the crimper movement motor 238, that the crimper 32′ has reached the position where the crimper 32′ can face the first binding position B1. Similarly, it is ascertained, based on a pulse signal output from a rotary encoder of the crimper pivot motor 239, that the crimper 32′ has reached the crimping angle. If the type of the binding process instructed by the post-processing command is “parallel binding process,” the controller 100b omits the above-described operation of rotating the crimper 32′. In other words, the crimper 32′ moves in the main scanning direction while maintaining the standby angle.

In step S802, the controller 100b drives the conveyance roller pairs 10 and 11 to start conveying the sheet P on which an image is formed by the image forming apparatus 2. In step S803, the controller 100b determines whether the first liquid application position B1 on the sheet P faces first the liquid application unit 140 (more specifically, the liquid application head 146). In other words, the controller 100b determines whether the liquid application unit 140 has faced the first liquid application position B1 on the sheet P. When the first liquid application position B1 on the sheet P has not faced the liquid application unit 140 (NO in step S803), the controller 100b repeats the processing in step S803. In other words, the controller 100b continues driving the conveyance roller pairs 10 and 11 until the first liquid application position B1 on the sheet P faces the liquid application head 146 (YES in step S803). When the controller 100b determines that the first liquid application position B1 on the sheet P has faced the liquid application head 146 (YES in step S803), in step S804, the controller 100b causes the conveyance roller pairs 10 and 11 to stop conveying the sheet P. It is ascertained, based on a pulse signal output from a rotary encoder of a motor that drives the conveyance roller pairs 10 and 11, that the first liquid application position B1 on the sheet P has faced the liquid application head 146.

In step S805, the controller 100b causes the liquid application unit 140 to execute the process of applying liquid to the first liquid application position B1 on the sheet P. More specifically, the controller 100b rotates the application-head movement motor 151 in the first direction to bring the liquid application head 146 into contact with the first liquid application position B1 on the sheet P. The controller 100b changes the pressing force of the liquid application head 146 (i.e., the amount of rotation of the application-head movement motor 151) depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed later. The amount of rotation of the application-head movement motor 151 can be ascertained based on a pulse signal output from a rotary encoder of the application-head movement motor 151.

In step S806, the controller 100b drives the conveyance roller pairs 10, 11, 14, and 15 to place a sheet P on the internal tray 22. In step S806, the controller 100b also moves the side fences 24L and 24R in the main scanning direction to align the position of the sheet P or the sheet bundle Pb placed on the internal tray 22 in the main scanning direction. In short, the controller 100b performs so-called jogging.

In step S807, the controller 100b determines whether the number of sheets P placed on the internal tray 22 has reached the given number of sheets Np indicated by the post-processing command. When the controller 100b determines that the number of sheets P placed on the internal tray 22 has not reached the given number of sheets Np (NO in step S807), the controller 100b executes the operations of steps S802 to S807 again until the number of sheets P placed on the internal tray 22 reaches the given number of sheets Np (YES in step S807).

By contrast, when the controller 100b determines that the number of sheets P that are placed on the internal tray 22 has reached the given number of sheets Np (YES in step S807), in step S808, the controller 100b causes the crimper 32′ to crimp the binding position B1 (corresponding to the first liquid application position B1) on the sheet bundle Pb to which the liquid has been applied by the liquid application unit 140. In step S808, the controller 100b also rotates the conveyance roller pair 15 to eject the crimped sheet bundle Pb to the second ejection tray 26.

In step S809, the controller 100b determines whether the number of sheet bundles Pb thus ejected to the second ejection tray 26 has reached the requested number of copies Mp indicated by the post-processing command. When the controller 100b determines that the number of the sheet bundles Pb ejected to the second ejection tray 26 has not reached the requested number of copies Mp (NO in step S809), the controller 100b repeats the processing of steps S802 to S809 until the number of the sheet bundles Pb ejected to the second ejection tray 26 reaches the requested number of copies Mp (YES in step S809).

When the controller 100b determines that the number of sheet bundles Pb ejected to the second ejection tray 26 reaches the requested number of copies Mp (YES in step S809), in step S810, the controller 100b drives the liquid-application-unit movement motor 137 to move the liquid application unit 140 to the standby position HP1 (see FIGS. 25B) and drives the crimper movement motor 238 to move the crimper 32′ to the standby position HP2 (see FIG. 23A). When the posture that is instructed by the post-processing operation is the “oblique binding posture,” in step S810, the controller 100b drives the application-head pivot motor 150 and the crimper pivot motor 239 to rotate the liquid application unit 140 and crimper 32′ and the parallel binding posture (standby angle) into the parallel binding posture. On the other hand, when the posture that is instructed by the post-processing command is the “parallel binding posture,” the operation of rotating the liquid application unit 140 and the crimper 32′ to the parallel binding posture (standby angle) is skipped. In steps S801 and S810, the execution order of the movement in the main scanning direction and the rotation in the forward and reverse directions of the liquid application unit 140 and the crimper 32′ is not limited to the aforementioned order and may be reversed.

The present disclosure can be applied to not only the edge binder 25 that executes edge binding but also to the saddle binder 28 that executes saddle stitching.

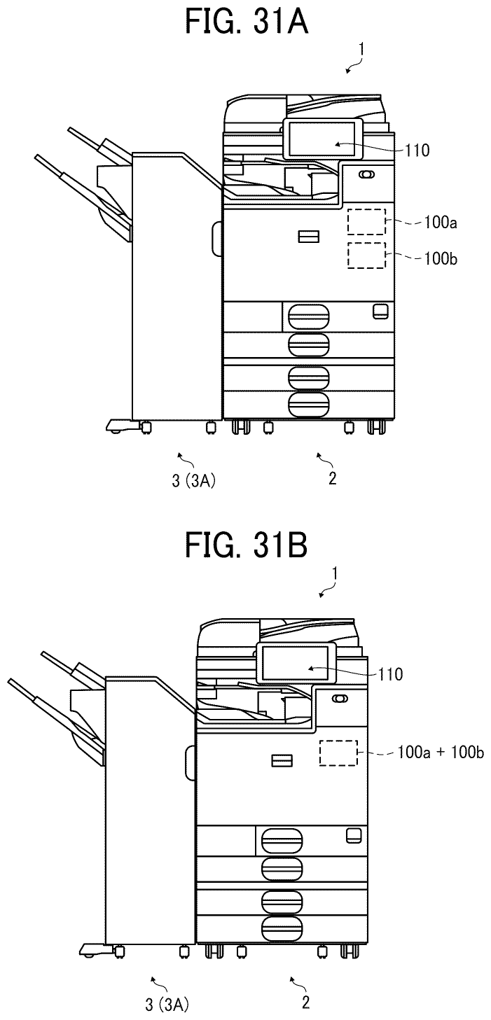

The controller 100b of the post-processing apparatus 3A according to the second embodiment illustrated in FIG. 22 is provided separately from the controller 100a of the image forming apparatus 2 as in the configuration of FIG. 1. However, embodiments of the present disclosure are not limited to the above-described configuration. For example, as illustrated in FIG. 31A, the controller 100b of the post-processing apparatus 3A may be disposed in the image forming apparatus 2. Further, as in the configuration of FIG. 31B, the controller 100b of the post-processing apparatus 3A may be integrated with the controller 100a of the image forming apparatus 2.

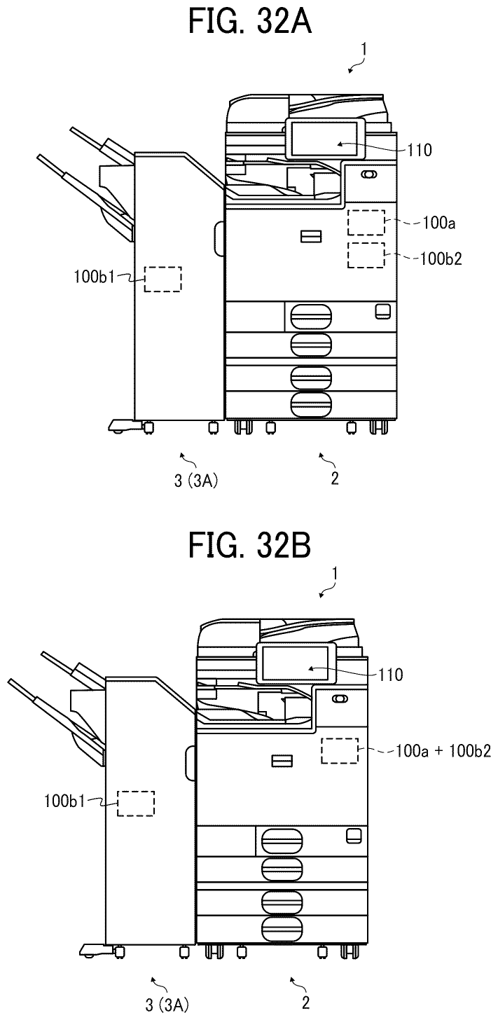

Similarly with FIG. 32A, the controller 100b of the post-processing apparatus 3A may be divided into a controller 100b1 (e.g., a driver system (such as a motor)) and a controller 100b2 (a detector system (such as a sensor)) according to the function, and the controller 100b2 of the post-processing apparatus 3A may be disposed in the image forming apparatus 2. Further, as in the configuration of FIG. 32B, the controller 100b2 of the post-processing apparatus 3A disposed in the image forming apparatus 2 may be integrated with the controller 100a of the image forming apparatus 2.

As described above, the control method by the controller 100b described above is implemented by cooperation between hardware resources of a computer and a program as computer software. In other words, the control method may be a method executed by a computer causing an arithmetic device, a storage device, an input device, an output device, and a control device to operate in cooperation with each other based on a program. The program may be written in, for example, a storage device or a storage medium and distributed with the storage device or the storage medium, or may be distributed through, for example, an electric communication line.

Embodiments of the present disclosure are not limited to the above-described embodiments, and numerous additional modifications and variations are possible in light of the teachings. The technical contents included in the technical ideas described in the appended claims are included within the scope of the present disclosure. The above-described embodiments represent examples, and various modifications can be achieved by those skilled in the art from the disclosed contents. Such modifications are included in the technical scope described in the scope of claims.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The aspects of the present disclosure are, for example, as follows.

### First Aspect

A medium processing apparatus includes a liquid applier to perform liquid application to a part of at least one medium, a medium processing device to perform desired processing on a bundle of media including the at least one medium on which the liquid application has been performed by the liquid applier, a liquid storage to store liquid used for the liquid application by the liquid applier, a liquid detector to detect an amount of liquid in the liquid storage, and a controller to control a supply operation of supplying the liquid to the liquid applier to set the liquid applier to a liquid applicable state in which the liquid applier can apply the liquid to the at least one medium based on information from the liquid detector. The controller changes a transition time to the liquid applicable state, based on the amount of liquid in the liquid storage detected by the liquid detector.

### Second Aspect

In the medium processing apparatus according to the first aspect, the controller changes the transition time so as to immediately transition to the liquid applicable state, when the amount of liquid in the liquid storage is equal to or greater than a predetermined amount.

### Third Aspect

In the medium processing apparatus according to the first or second aspect, the controller changes the transition time so as to transition to the liquid applicable state after waiting for a predetermined time, when the amount of liquid in the liquid storage is less than a predetermined amount.

### Fourth Aspect

In the medium processing apparatus according to any one of the first to third aspects, the controller compares a supplying time of the liquid in the supply operation with a preset time to determine the amount of liquid in the liquid storage.

### Fifth Aspect

The medium processing apparatus according to the fourth aspect further includes an input device to change the preset time in response to a user operation. The controller sets the preset time based on an input value from the input device.

### Sixth Aspect

An image forming system includes an image forming apparatus to form images on a plurality of media and the medium processing apparatus according to any one of the first to fifth aspects to perform the desired processing on the plurality of media on which the images have been formed by the image forming apparatus.

1. A medium processing apparatus, comprising:
a liquid applier to apply liquid to a part of a medium to perform a liquid application;
a medium processing device to perform desired processing on a bundle of media including the medium subjected to the liquid application;
a liquid storage to store liquid used for the liquid application by the liquid applier;
a liquid detector to detect an amount of liquid in the liquid storage; and
circuitry configured to control a supply operation of supplying the liquid to the liquid applier to set a liquid applicable state in which the liquid applier can apply the liquid to the at least one medium based on information from the liquid detector,
the circuitry configured to change a transition time to the liquid applicable state, based on the amount of liquid in the liquid storage detected by the liquid detector.

2. The medium processing apparatus according to claim 1,
wherein the circuitry changes the transition time so as to immediately transition to the liquid applicable state, when the amount of liquid in the liquid storage is equal to or greater than a predetermined amount.

3. The medium processing apparatus according to claim 1,
wherein the circuitry changes the transition time so as to transition to the liquid applicable state after waiting for a predetermined time, when the amount of liquid in the liquid storage is less than a predetermined amount.

4. The medium processing apparatus according to claim 1,
wherein the circuitry compares a supplying time of the liquid in the supply operation with a preset time to determine the amount of liquid in the liquid storage.

5. The medium processing apparatus according to claim 4, further comprising an input device to change the preset time in response to a user operation,
wherein the circuitry sets the preset time based on an input value from the input device.

6. An image forming system, comprising:
an image forming device to form an image on media constituting a bundle of media;
a liquid applier to apply liquid to a part of a medium to perform a liquid application;
a medium processing device to perform desired processing on a bundle of media on which the image is formed by the image forming device, the bundle of media including the medium subjected to the liquid application;
a liquid storage to store liquid used for the liquid application by the liquid applier;
a liquid detector to detect an amount of liquid in the liquid storage; and
circuitry configured to control a supply operation of supplying the liquid to the liquid applier to set a liquid applicable state in which the liquid applier can apply the liquid to the at least one medium based on information from the liquid detector,
the circuitry configured to change a transition time to the liquid applicable state, based on the amount of liquid in the liquid storage detected by the liquid detector.
